(19) United States
(12) Patent Application Publication
(10) Pub. No.: US 2026/0304063 A1
(43) Pub. Date: Oct. 1, 2026

(54) Loudspeaker Control in a Plurality of Frequency Bands

(71) Applicant: Audioscenic Limited, Southampton (GB)

(72) Inventors: Yury Ushakov, Southampton (GB); Davi Carvalho, Southampton (GB); Jacob Hollebon, Southampton (GB); Marcos Simón, Southampton (GB); Daniel Wallace, Southampton (GB)

(21) Appl. No.: 19/563,921

(22) Filed: Mar. 11, 2026

(30) Foreign Application Priority Data
Mar. 26, 2025 (GB) 2504473.6

(51) Int. Cl. H04S 7/00

(52) U.S. Cl. CPC H04S 7/307; H04S 7/303; H04S 7/305; H04S 2400/11; H04S 2420/01

(57) ABSTRACT

A computer-implemented method of generating audio signals for an array of loudspeakers in a plurality of frequency bands is provided, and comprises: obtaining the plurality of frequency bands; receiving a plurality of input audio signals to be reproduced, by the array, in an acoustic environment, wherein each of the plurality of input audio signals comprises a sub-signal in each of the plurality of frequency bands, and wherein each of the sub-signals in at least one of the plurality of frequency bands is to be reproduced at a respective subset of a set of control points, CPs; receiving position information indicative of a position of each of a mobile subset of the set of CPs; selecting, from a set of predetermined Sound Field Control, SFC, modes and based on the position information, a SFC mode for each of the frequency bands; and generating an output audio signal for each of the loudspeakers by applying, for each of the frequency bands, an SFC algorithm corresponding to the SFC mode selected for the frequency band to the sub-signals of the frequency band.

### RELATED APPLICATION

This application claims priority under 35 U.S.C. § 119 or 365 to Great Britian Application No. 2504473.6, filed Mar. 26, 2025. The entire teachings of the above application are incorporated herein by reference.

### TECHNICAL FIELD

The present disclosure relates to a computer-implemented method of generating audio signals for an array of loudspeakers in a plurality of frequency bands, and to a corresponding apparatus and computer program. The method, apparatus, and computer program may be specially adapted for use in a vehicle, such as a car.

### BACKGROUND

A loudspeaker array may be used to reproduce input audio signals in a listening environment using a variety of signal processing algorithms, depending on the type of audio signal to be reproduced and the nature of the listening environment. However, accurate delivery of sound in a car cabin is complex due to the high influence of the environment on the signals reproduced by the loudspeaker array and the changing positions of the listeners within the environment.

### SUMMARY

Aspects of the present disclosure are defined in the accompanying independent claims.

### BRIEF DESCRIPTION OF THE DRAWINGS

Examples of the present disclosure will now be explained with reference to the accompanying drawings in which:

FIG. 1 shows a flowchart illustrating a computer-implemented method of generating audio signals for an array of loudspeakers in a plurality of frequency bands.

FIG. 2A shows logic elements of an apparatus configured to perform the method of FIG. 1.

FIG. 2B shows logic elements of an alternative apparatus configured to perform the method of FIG. 1.

FIG. 3 shows further logic elements of the apparatus of FIGS. 2A and 2B.

FIG. 4 shows a block diagram of the hardware of an apparatus for implementing any of the methods described herein.

FIG. 5 shows a flowchart of the algorithm of typical usage of TFs for SFC.

FIG. 6 shows an example of four control zones in a car cabin for low frequencies. The same sound channel is to be delivered to both ears of a single listener. The four control zones are represented by different types of control points (different markers).

FIG. 7 shows an example of two control zones, where the same sound channel is delivered to four ears of two different listeners.

FIG. 8 shows an example of four control zones of smaller size.

FIG. 9 shows an example of four control zones around the ears of two listeners.

FIG. 10 shows an example of the switching curve between measured and modelled TFs at different frequencies depending on the distance between a loudspeaker and a CP. Below the curve measured TFs are used, while the modelled ones are used above.

FIG. 11 shows steps of the TF measurement procedure.

FIG. 12 shows steps of the procedure of interpolating TFs from the irregular cloud of measurements.

FIG. 13 shows a 2D example of head- or head-and-torso simulator positions for TF measurements. The TF measurement positions are indicated using black circles. Each position represents the centre of the measurement head or the centre between measurement microphones.

Throughout the description and the drawings, like reference numerals refer to like parts.

### DETAILED DESCRIPTION

In general terms, the present disclosure relates to a computer-implemented method of generating audio signals for an array of loudspeakers in a plurality of frequency bands, in which method a respective Sound Field Control, SFC, mode is selected for each of the plurality of frequency bands. The present disclosure relates primarily to the choice of frequency bands, selection of SFC modes, and adjustment of the SFC modes' parameters depending on listeners' positions.

### Method of Generating Audio Signals

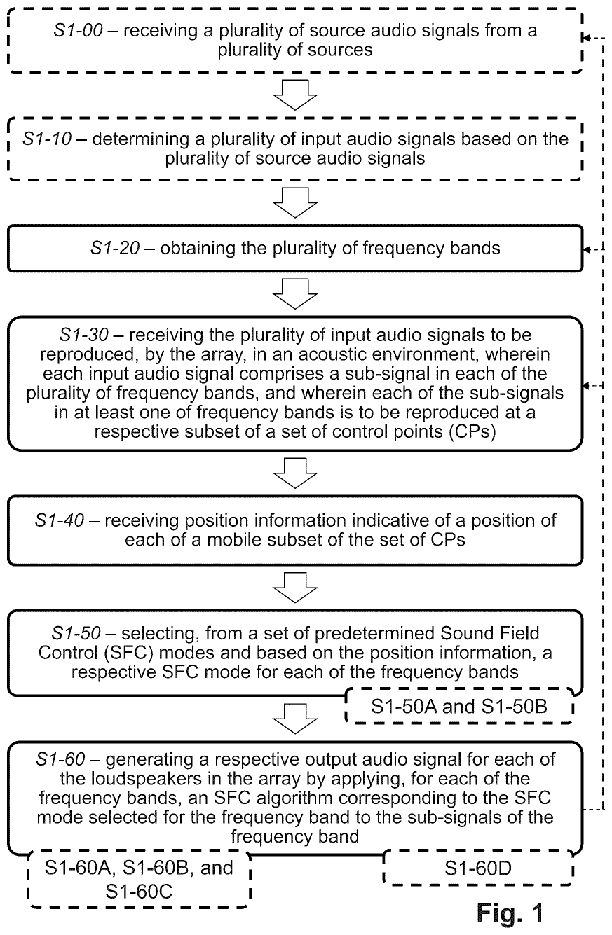

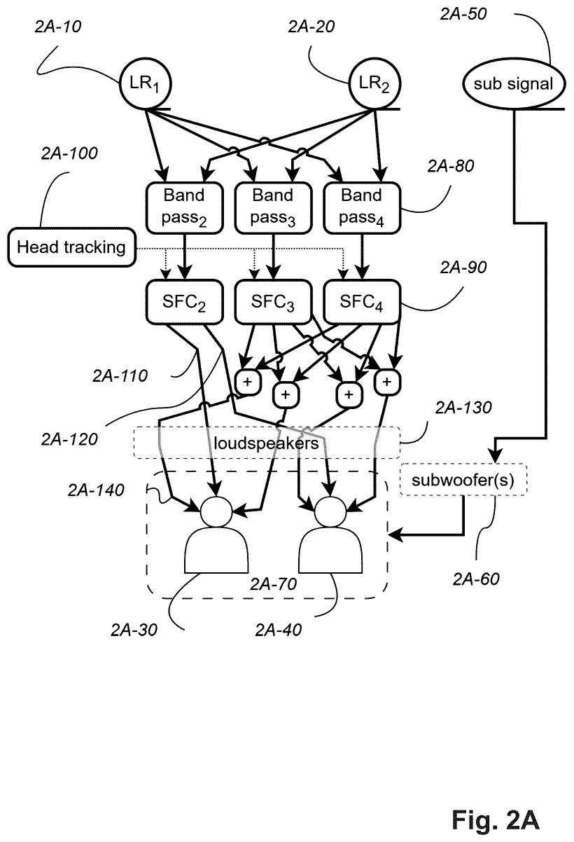

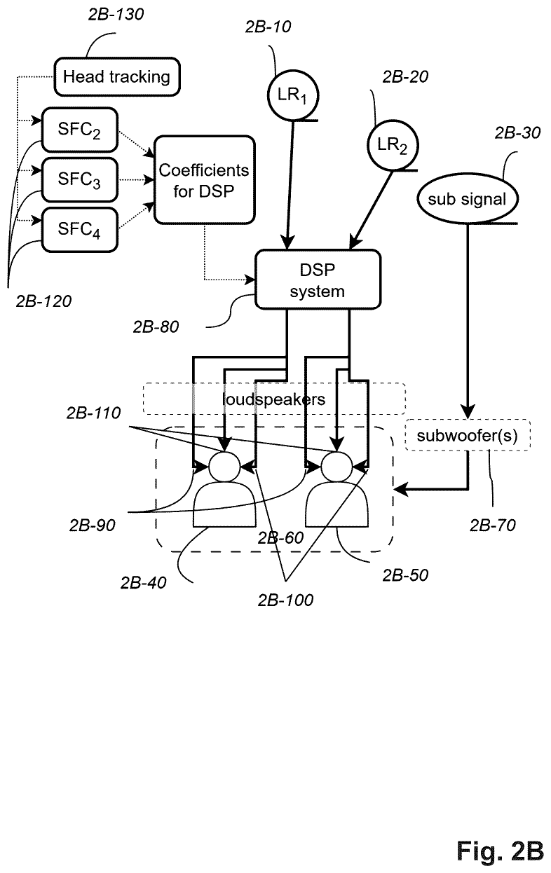

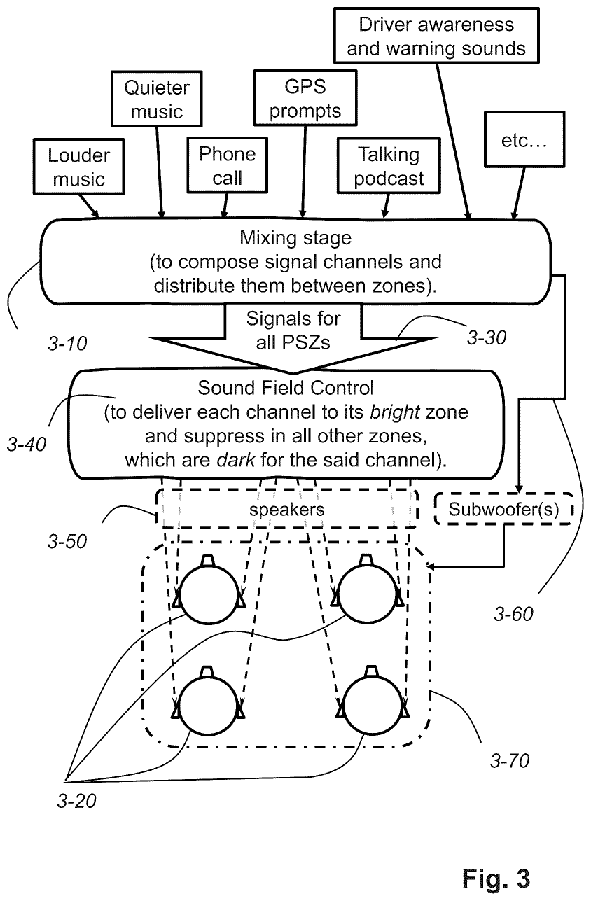

A computer-implemented method of generating audio signals for an array of loudspeakers in a plurality of frequency bands is shown in FIG. 1. The method may be performed by the apparatus described below with reference to FIGS. 2A, 2B, and 3.

At step S1-20, the plurality of frequency bands is obtained (e.g., determined as part of performing the method, retrieved from memory or received from another source such as a database). Any number of frequency bands may be obtained, but, in some examples of the present disclosure, the plurality of frequency bands comprises at least one of a first, a second, a third, or a fourth frequency band with characteristics defined in more detail below. Each of the plurality of frequency bands has a lower and an upper limit.

At step S1-30, a plurality of input audio signals is received. Each input audio signal is to be reproduced, by the array, in an acoustic environment. Each input audio signal comprises a sub-signal in each of the plurality of frequency bands. For example, each input audio signal may comprise a first sub-signal in the first frequency band, a second sub-signal in the second frequency band, a third sub-signal in the third frequency band, and a fourth sub-signal in the fourth frequency band. Each of the sub-signals in at least one of the plurality of frequency bands is to be reproduced at a respective subset of a set of control points (CPs). For example, the first sub-signal of a first input audio signal is to be reproduced throughout the acoustic environment, the second sub-signal of the first input audio signal is to be reproduced at a subset A of the set of CPs, the third and fourth sub-signals of the first input audio signal are to be reproduced at a subset B of the set of CPs, the first sub-signal of a second input audio signal is to be reproduced throughout the acoustic environment, the second sub-signal of the second input audio signal is to be reproduced at a subset C of the set of CPs, and the third and fourth sub-signals of the second input audio signal are to be reproduced at a subset D of the set of CPs. A control point is a point in the acoustic environment at which a characteristic of the sound field (e.g., the sound pressure amplitude and/or phase) is to be controlled. In some cases, the respective subset of the set of CPs may comprise one or more CPs at or around the head of one or more listeners. In other cases, the respective subset of the set of CPs may comprise one or more CPs at or around a left or right ear of one or more listeners. The manner in which the position of CPs may be chosen is described in more detail below.

Those skilled in the art will appreciate that the sub-signals in some of the frequency bands may have a far smaller amplitude compared to sub-signals in other of the frequency bands, or even a zero amplitude; this will depend, among other factors, on what the content of the input audio signal is and how it is processed before being used as input in this method. Accordingly, in this disclosure, references to a signal or sub-signal do not imply that the signal carries audio content in all circumstances.

Indeed, at step S1-00, a plurality of source audio signals may be received from a plurality of sources (e.g., audio sources such as a music player, a telephone system, a navigation system, etc.), each source audio signal to be reproduced, by the array, at one or more CPs in the acoustic environment. At step S1-10, the plurality of input audio signals may be determined based on the plurality of source audio signals.

In one implementation, at least one input audio signal is determined based on two or more of the source audio signals which are to be reproduced at the same CP or CPs. In other words, the source audio signals may be mixed to obtain the plurality of input audio signals. A source audio signal may need to be reproduced at multiple CPs; in that case, the source audio signal may be split into multiple input audio signals which are each to be reproduced at one or more CPs.

At step S1-40, position information indicative of a position of each of a mobile subset of the set of CPs is received. For example, the information indicative of a position of each of the mobile subset of the set of CPs may comprise head tracking data received from a head tracking system for tracking the head movements of one or more listeners. The CPs of the mobile subset of the set of CPs are those which may move within the acoustic environment, and whose position may therefore change and need to be received repeatedly. The remainder of the CPs of the set of CPs form part of a static subset of the set of CPs which do not move, or are considered not to move, with respect to the acoustic environment (e.g., with respect to the array) and whose position may therefore be predetermined.

Those skilled in the art will appreciate that steps S1-20, S1-30, and S1-40 may be performed in a different order. Indeed, what is obtained or received at each of these steps can be obtained or received independently of the performance of the other steps. For example, the plurality of input audio signals may have already been received when the plurality of frequency bands is obtained. Moreover, one or more of steps S1-20, S1-30, and S1-40 may be omitted if what is obtained or received at that or those steps is already available to the apparatus performing the method, e.g., when the method is repeated for a new plurality of input audio signals. Step S1-40 may not be repeated or may be omitted entirely, e.g., in an environment, such as a car, in which even the position of the mobile subset of the set of CPs is considered to be fairly static.

At step S1-50, based on the received position information and from a set of predetermined Sound Field Control, SFC, modes, a respective SFC mode is selected for each of the plurality of frequency bands. The respective mode is band-specific. Each selected SFC may be particularly suitable for processing signals in the frequency band for which it is selected. Depending on whether the position information is changing, step S1-50 may involve maintaining an existing selection or altering the selection, e.g., when the method is repeated for a new plurality of input audio signals. Each of the predetermined SFC modes has a corresponding SFC algorithm, as explained in more detail below.

At step S1-60, a respective output audio signal is generated for each of the loudspeakers in the array by applying, for each of the plurality of frequency bands, an SFC algorithm corresponding to the SFC mode selected for the frequency band to the sub-signals of the frequency band. In other words, each sub-signal is processed according to the SFC algorithm corresponding to the SFC mode selected for the frequency band of that sub-signal, and the thus-processed sub-signals may then be provided (separately or in combination with other sub-signals) to each of the loudspeakers in the array. Possible ways of processing the sub-signals are discussed in more detail below with reference to FIGS. 2A and 2B.

### Repetition of and Modifications to the Method

Steps S1-00 to S1-60 of the method of FIG. 1 may be repeated with at least one new plurality of input audio signals. These steps may be repeated in real time and/or periodically.

When repeating the method, not all its steps need to be performed again. For example, steps S1-20, S1-40, and/or S1-50 may be performed once, during an initialization phase, and need not be repeated thereafter. For example, the positions of the CPs may be predetermined or estimated based on a model rather than being received from a sensor, and the selection of SFC modes may be pre-computed. The need to perform steps S1-20, S1-40, and S1-50 in real time can thus be avoided, thereby reducing the computational resources required to implement the method.

If the number and/or position of the listeners changes over time but it is known, or is assumed, that their movement will be such that the selection of SFC mode will not change over time (for example, if each of the listeners is determined to remain within a respective given region of space), then step S1-50 need not be repeated for that particular amount of time. For example, step S1-50 can be performed once, during an initialization phase, and need not be repeated thereafter until it is determined that at least one of the listeners no longer remains within the respective given region of space.

As would be understood by a skilled person, the steps of the method may be performed with respect to successively received frames of a plurality of input audio signals. Accordingly, steps S1-00 to S1-60 need not all be completed before they begin to be repeated. For example, in some implementations, steps S1-00 or S1-30 are performed a second time before step S1-60 has been performed a first time.

### Frequency Bands

At step S1-20 of the method of FIG. 1, the plurality of frequency bands is obtained. The plurality of frequency bands may comprise or consist of at least one of a first, a second, a third, or a fourth frequency band as described below.

The first frequency band may be in a range of 0 to 20 Hz to between 60 and 100 Hz, e.g., a range of from 20 Hz to any of 60, 70, 80, 90, 100 Hz. The second frequency band may be in a range of between 60 and 100 Hz to between 200 and 300 Hz, e.g., in a range of from any of 60, 70, 80, 90, 100 Hz to any of 200, 220, 240, 260, 280, 300 Hz. The third frequency band may be in a range of between 200 and 300 Hz to between 1 and 3 kHz, e.g., a range of from any of 200, 220, 240, 260, 280, 300 Hz to any of 1, 1.5, 2, 2.5, 3 kHz. The fourth frequency band may be in a range of between 1 and 3 kHz to between 20 and 22 kHz, e.g., a range of between 200 and 300 Hz to between 1 and 3 kHz, e.g., a range of from any of 1, 1.5, 2, 2.5, 3 kHz to any of 20, 20.5, 21, 21.5, 22 kHz.

More generally, the first frequency band may be lower than the second frequency band, the third frequency band and/or the fourth frequency band; the second frequency band may be lower than the third frequency band and/or the fourth frequency band and may be higher than the first frequency band; the third frequency band may be lower than the fourth frequency band and may be higher than the first frequency band and/or the second frequency band; and the fourth frequency band may be higher than the first frequency band, the second frequency band and/or the third frequency band.

Those skilled in the art will understand that there may be an overlap between certain frequency bands; in other words, there may be an overlap between the ranges of certain frequency bands. For example, a first frequency band may be in a range of 20 to 100 Hz and a second frequency band may be in a range of 60 to 300 Hz.

The frequency bands may be based on geometrical constraints of a vehicle, such as a car, i.e., the frequency bands may be tailored for use in a particular type and/or model of vehicle. For example, the frequency bands may be chosen to give rise to certain effects in the sound reproduced by the array of loudspeakers in the vehicle, as a result of attenuation, reflections, distortion, etc. within the vehicle.

### Sound Field Control (SFC) Modes

At step S1-50 of the method of FIG. 1, a respective Sound Field Control, SFC, mode for each of the plurality of frequency bands is selected. This selection is based on the plurality of frequency bands, which, as explained above, may comprise or consist of at least one of a first, a second, a third, or a fourth frequency band.

In some examples, the SFC mode selected for the first frequency band is a control-point-position-independent mode. For example, the SFC algorithm corresponding to the SFC mode may not alter the sub-signal to which it is applied.

The SFC mode selected for the other bands may be a control-point-position-dependent mode.

In some examples, the SFC mode selected for the second frequency band may use measured transfer functions, TFs. In some examples, the SFC mode selected for the third frequency band may use measured TFs and/or modelled TFs. In some examples, the SFC mode selected for the fourth frequency band may use modelled TFs.

More generally, an SFC mode selected for at least one particular frequency band may use measured or modelled TFs. For frequency bands in a lower frequency range, the selected SFC mode may use measured TFs; for frequency bands in a higher frequency range, the selected SFC mode may use modelled TFs. However, in certain frequency bands, both measured and modelled TFs may be used. The manner in which measured and modelled transfer functions may be obtained is described in more detail below.

Whether a measured or modelled TF is used may also depend on the relative position of the CPs and loudspeakers, particularly in frequency bands in which both measured and modelled TFs may be used. As an example, whether the SFC mode selected for the third frequency band and for a given pair of CP and loudspeaker uses measured TFs or modelled TFs may depend on the distance between the CP and the loudspeaker. The dependency may be such that the TF is measured when the distance is below a threshold distance, and modelled when the distance is above that threshold distance.

Using, in certain frequency bands, both measured and modelled TFs, may involve using hybrid measured and modelled TFs. For example, the SFC mode selected for the third frequency band may use hybrid measured and modelled TFs, in which a part of the hybrid TF is measured for frequencies below a transition frequency within the third frequency band and another part of the hybrid TF is modelled for frequencies above the transition frequency.

In this case, whether a measured or modelled TF is used may still depend on the relative position of the CPs and loudspeakers. For example, the transition frequency may depend on the distance between the CPs and the loudspeakers. The dependency may be such that the transition frequency is higher the smaller the distance is.

As noted above, each selected SFC mode (including the corresponding SFC algorithm) may be particularly suitable for processing signals in the frequency band for which it is selected. Broadly speaking, two types of SFC algorithm are used: energy contrast (EC) algorithms, and crosstalk cancellation (CTC) algorithms. An energy contrast SFC algorithm may be configured to increase (e.g., maximize) the energy of a given input audio signal reproduced at at least one CP of the set of CPs relative to the energy of the given input audio signal reproduced at the other CPs of the set of CPs. A crosstalk cancellation SFC algorithm may be configured to reproduce a magnitude and phase of a given input audio signal at at least one CP of the set of CPs and to cancel leakage of the given input signal at the other CPs of the set of CPs. In one implementation, the SFC algorithm for the second frequency band may involve an energy contrast method, such as ACC, or EDM; alternatively, it may involve a crosstalk cancellation method, such as PM, weighted PM, modified PM. Additionally or alternatively, the SFC algorithm for the third and/or fourth frequency band may involve a crosstalk cancellation method, such as PM, weighted PM, modified PM.

### Transfer Function Measurements

When measured TFs are used, these are measured between each of the loudspeakers and a number of CPs of a sampling grid having a given density.

In some examples, the given density is not uniform across the sampling grid. For example, the sampling grid may be more dense around an expected position of a head and/or an ear of each of one or more listeners. The position may be an expected position at a particular time. The density may be frequency-dependent: in some frequency bands a higher density in certain regions of the grid is desirable, whereas in other frequency bands a lower density is sufficient.

For example, the predefined density for the second frequency band may be at most 20-30 cm (e.g., 25 cm) between adjacent CPs of the sampling grid. As another example, the predefined density for the third frequency band may be at most a quarter of a wavelength of an upper limit of the third frequency band (e.g., 3 kHz) between adjacent CPs of the sampling grid.

There may also be a correspondence between the frequency bands described above and the CPs that are used. For example, the second frequency band may be for reproduction at a subset of the set of CPs at or around the head of one or more listeners. As another example, the second or third or fourth frequency band may be for reproduction at a subset of the set of CPs at or around an ear of one or more listeners. As yet another example, the second frequency band may be for reproduction at a subset of the set of CPs at or around the head of one or more listeners, while the third and/or fourth frequency band may be for reproduction at a subset of the set of CPs at or around the ear of one or more listeners.

### Apparatus for Performing the Method-Logic Elements

Logic elements of an apparatus configured to perform the method of FIG. 1 are shown in FIGS. 2A and 2B. Both the implementation of FIG. 2A and the implementation of FIG. 2B are suitable for carrying out the method. The logic elements of FIGS. 2A and 2B are described in more detail below.

In an apparatus configured such as in FIG. 2A, step S1-60 of the method of FIG. 1 may comprise steps S1-60A, S1-60B, and S1-60C.

At step S1-60A, each input audio signal of the plurality of input audio signals is separated into separate sub-signals, with one sub-signal in each of the plurality of frequency bands.

At step S1-60B, a respective output audio signal for each of the loudspeakers in the array is generated by applying, to each of the sub-signals and separately from the other channel sub-signals, the SFC algorithm corresponding to the SFC mode selected for the frequency band of the sub-signal.

At step S1-60C, at least some of the sub-signals are combined to generate the respective output audio signals, wherein the combined sub-signals are to be reproduced by a same loudspeaker of the loudspeaker array.

In contrast, in an apparatus configured such as in FIG. 2B, step S1-50 of the method of FIG. 1 may comprise steps S1-50A and S1-50B and step S1-60 may comprise step S1-60D.

At step S1-50A, the same selecting step as in step S1-50 is performed. Subsequently, at step S1-50B, based on the SFC algorithms corresponding to the SFC modes selected for each of the plurality of frequency bands, a common set of digital signal processing, DSP, coefficients is generated.

At step S1-60D, at a DSP system using the set of DSP coefficients, a respective output audio signal for each of the loudspeakers in the array is generated by applying, to each of the sub-signals, the SFC algorithm corresponding to the SFC mode selected for the frequency band of the sub-signal through the use of the common set of DSP coefficients.

Those skilled in the art will understand that the principles of each of the implementations of FIGS. 2A and 2B may be applied in a “hybrid” implementation. In other words, some sub-signals may be processed separately, and some sub-signals may be processed together at a DSP system.

The logic elements shown in FIGS. 2A and 2B may form part of a Sound Field Control module of the apparatus described above. However, the apparatus may comprise further modules, as shown in FIG. 3. The apparatus may comprise a mixing stage for implementing steps S1-00 and S1-10 of the method of FIG. 1. FIG. 3 is described in more detail below.

### Apparatus for Performing the Method—Hardware

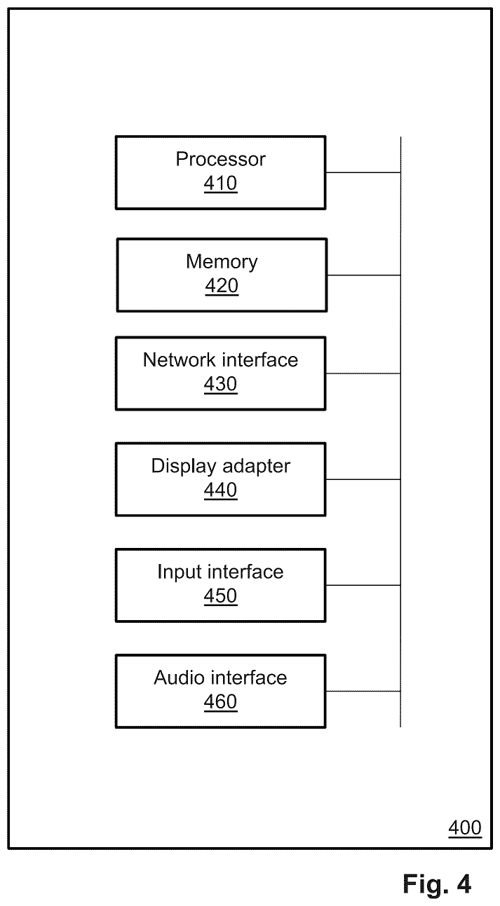

A block diagram of an exemplary apparatus 400 for implementing any of the methods described herein, such as the method of FIG. 1, is shown in FIG. 4. The apparatus 400 may implement the logic elements described in relation to FIGS. 2A, 2B, and 3.

The apparatus may be (specially) adapted for use in a vehicle, such as a car (not shown), and installed therein.

The apparatus 400 comprises one or more processors 410 (e.g., a digital signal processor) arranged to execute computer-readable instructions as may be provided to the apparatus 400 via one or more of a memory 420, a network interface 430, or an input interface 450. The memory 420 may comprise any computer-readable medium capable of storing the instructions, e.g., a non-transitory computer-readable medium. The instructions may be provided as a computer program, for example in a computer program product.

The memory 420, for example a random-access memory (RAM), is arranged to be able to retrieve, store, and provide to the processor 410, instructions and data that have been stored in the memory 420. The network interface 430 is arranged to enable the processor 410 to communicate with a communications network, such as the Internet. The input interface 450 is arranged to receive user inputs provided via an input device (not shown) such as a mouse, a keyboard, or a touchscreen. The processor 410 may further be coupled to a display adapter 440, which is in turn coupled to a display device (not shown). The processor 410 may further be coupled to an audio interface 460 which may be used to output audio signals to one or more audio devices, such as an array of loudspeakers. The audio interface 460 may comprise a digital-to-analog converter (DAC) (not shown), e.g., for use with audio devices with analog input(s).

Various more detailed approaches for selecting and applying the SFC mode are now described, along with some context for those approaches.

### Abbreviations

The following abbreviations are used below:
ACC—Acoustic Contrast Control
CP—Control Point
DSP—Digital Signal Processing
EDM—Energy Difference Maximisation
FIR—Finite Impulse Response
HRTF—Head-Related Transfer Function
IDW—Inverse Distance Weighting
IIR—Infinite Impulse Response
PM—Pressure Matching
PSZ—Personal Sound Zone
RBF—Radial Basis Function
SFC—Sound Field Control
TF—Transfer Function

### Terminology

A control point may be a specific spatial location within the sound field where the acoustic parameters—such as sound pressure, phase, or intensity—are measured, monitored, or controlled to achieve the desired sound field characteristics.

A zone (or control zone) may be a spatially defined region represented by a collection of CPs, within which the sound field is engineered to meet a specific target condition, such as uniform delivery of a desired signal (bright zone) or suppression of unwanted sound (dark zone).

A personal sound zone may be a higher-level spatial concept, encompassing multiple zones, designed to represent an area where a listener experiences a targeted overall acoustic behavior.

A sweet spot may be the optimal listening position within a room or sound field where the sound quality is perceived as best, with accurate imaging, tonal balance, and spatial effects as intended by the sound system's design.

Head tracking may be a technology that monitors the position and orientation of a listener's head, including yaw, pitch, and roll angles, using cameras, sensors, or other tracking devices. Its purpose is to determine precise ear positions in real time, enabling the system to adapt sound delivery by manipulating constructive and destructive interference patterns across frequencies at the corresponding control points.

### Context

The disclosure relates to the field of audio reproduction systems with loudspeakers and audio digital signal processing. More specifically, the disclosure relates to the field of Sound Field Control (SFC) in car cabins, whereby several sound sources are used together to generate spatial audio for a single or multiple listeners. In case of multiple listeners, the system may generate multiple spatially separate personal sound zones.

A car audio reproduction system is provided combining different frequency subbands, different sound field control methods, different methods of handling acoustic transfer functions, and different user position adaptive modes to deliver individual binaural sound to each listener in a car cabin.

The general topic under consideration is delivering individualized binaural sound to each listener in the car cabin while minimizing its leakage to other listeners. This means delivering one audio channel to one target ear without disturbing other ears. This approach allows for reproducing any possible sound effect which a human being can experience in the real world.

Some examples can be, but are not limited to:
1. real-world sounds recorded with a pair of microphones on a dummy head, so the recorded channels can be considered as a true binaural sound and delivered to a listener as is;
2. game engine sounds which provide information about various events around the gamer (gun shots, explosions, walking, voices, vehicle engines, etc.);
3. binauralized stereo tracks, i.e., stereo-channels processed by a set of filters which mimic mixing and reflecting of those channels in a listening room before coming to the ears;
4. binauralized spatial sound formats, e.g., 5.1, 7.1, 7.1.4, ambisonics, etc.;
5. mono signals (for example voice messages) which presume that the corresponding binaural signal comprises two identical channels.

Accurate delivery of binaural sound in a car cabin is complex due to the high influence of the environment on the signals reproduced by the loudspeakers. To deliver it, some approaches use various types of loudspeakers, various ways of positioning them in the cabin, and various SFC methods. An issue addressed herein is how to make a choice and combine effectively the loudspeaker set, their locations, SFC methods and their parameters to enable practical and accurate delivery of independent binaural sound to each individual listener across substantially the entire broadband frequency spectrum.

Typically SFC approaches make an assumption about the position of the listener. However, the performance degrades as the listeners move within the environment away from the assumed positions. So, an issue is optimally configuring user position tracking for an acceptable balance between the computationally expensive rate of SFC adaptation and the accuracy of binaural sound reproduction to each listener's current physical position at any instance of time. For low frequencies, this requires careful acoustical characterization of the car cabin by measuring transfer functions between speakers and multiple control points, therefore the methods of optimal measurements and usage of the measured data are also discussed herein.

As explained in the present disclosure, an implementation of spatial sound for multiple listeners delivers better performance with a few ingredients, namely:
Head tracking, as at higher frequencies SFC performs better when ears are less than 3-5 cm away from expected (target) positions;
Different types or settings of SFC algorithms in different frequency bands, due to frequency-dependent properties of sound field in small and reverberant enclosures such as car cabins;
Global SFC algorithms, which are capable of shaping sound for multiple listeners simultaneously;
Smart management of TFs between speakers and head/ear positions, as otherwise a system becomes either computationally greedy or may not provide high-quality spatial sound.

Known approaches, miss one or more listed components. The present disclosure combines the required ingredients so as to provide high-quality spatial sound in the full frequency range while keeping the computational resource consumption at the acceptable level.

### Overview of the Approach of the Present Disclosure

A system comprising four subbands for implementing spatial car audio by delivering binaural sound to each listener is disclosed herein. Subdivision of the frequency range is required for optimal SFC. This means that, for example, there is no need for precise ear position tracking at low frequencies, and there is no robust way of measuring TFs to be used by SFC algorithms at very high, but still acoustic, frequencies. So, the said subbands are mainly distinguished due to scales of sound field interference patterns. The inventors have arrived at the insight that the boundaries of the subbands should be defined by spatial scales and their relationships within the vehicle cabin, including:
cabin dimensions and material properties,
distances between seats,
distances between the listener's ears.
   The system assumes head tracking for precise delivery of the audio channels to the corresponding ears while suppressing crosstalk between channels. In other words, head tracking helps to adjust each frequency interference pattern to head or (at higher frequencies) ear positions. For that, at least two of the said subbands allow for effective using of measured TFs in SFC algorithms. Therefore, an aspect of the disclosure is a fast and accurate procedure of measuring TFs on an irregular and non-uniform measurement grid.

In frequency subbands where measuring TFs is not feasible, their models are used. However, in the third subband, as discussed below, the hybrid approach is possible. Hence, another aspect of the disclosure is a method for simultaneous use of modelled and measured TFs within the same subband, depending on frequency and the distance between a specific loudspeaker and a specific control zone.

For each subband, the following parameters are defined:
SFC algorithm type,
number and sizes of control zones and the number of control points within each zone,
whether the zones are tracked or static (changing coordinates of zonal CPs requires recalculating of SFC parameters, e.g., filter coefficients, which is computationally expensive; therefore, static control zones can be accepted in lower-frequency subbands),
type of TFs (modelled or measured),
dataset of measured TFs with a density defined by the wavelength of the highest frequency in the subband.

The specified four subbands pertain to SFC algorithms. Thus, another aspect of the disclosure is that any single loudspeaker may be used in one or more of the subbands. Signal adjustment to various types of loudspeakers is a separate matter.

### System Setup

The goal of the entire system is to reproduce given pressure signals at specified CPs in space. A zone or control zone may correspond to a single or multiple CPs in which the same sound channel is supposed to be delivered. Forming two zones for a listener by setting one or more CPs in a close proximity to the listener's ears means that binaural audio may be reproduced.

Also, as the sound frequency range is supposed to be split into subbands (explained below), it is possible that in different subbands there are different configurations of zones: different total numbers of zones, different spatial sizes, or different number of CPs in zones of the same size. Typical cases for different frequency ranges are the following:
a zone may include a single listener;
two or more listeners may belong to the same zone;
a zone may correspond to a single listener's ear.

In the SFC literature, the notion of a Personal Sound Zone (PSZ) is typically distinguished as a region in space dedicated to some listening experience of one person. This suggests a higher-level concept with respect to the zone definition above. Indeed, to deliver accurate spatial sound to a user, it is necessary to provide two independent control zones at the user's ears, at least, within certain frequency ranges, so, there will be two control zones within one PSZ.

### Input Mixing Stage

FIG. 3 shows two main components of the system of the present disclosure. The first one is the Mixing stage, which is required due to a number of possible sound sources to be reproduced to different listeners in the car cabin. The second is a set of Sound Field Control algorithms, which modify the signals for the zones to create specific loudspeaker signals to perform the sound field control.

As delivering spatial sound to more than one person means generating a number of personal sound zones, there can be a pre-mixing block (3-10 in FIG. 3) in the system, which can produce different combinations of sounds for the listeners. These sounds can be:
content personalised towards each given listener. For example, louder music for one listener and quieter music for the others, different EQ or spatial sound settings;
different content for each listener. For example, music for the front passenger, GPS prompts for the driver, a voice call for the left rear passenger and a talking podcast for the right rear passenger;
any mixture of the above, for example, the same music with different loudness levels for all passengers, and quiet music mixed with GPS prompts for the driver.

The example in FIG. 3 shows four listeners (3-20) in the car, so, in this case, “Signals for all PSZs” (3-30) will comprise four binaural (2-channel) signals to be processed by the “Sound Field Control” block (3-40) and played via the speakers (3-50) to reach listener ears properly. The subwoofer signal (3-60) can be also generated by the Mixing Stage to be played within the whole cabin (3-70) for all listeners.

### SFC Reproduction Stage

The proposed system reproduces personalized audio with listener head tracking in a car cabin. The system reproduces the personalized audio by using SFC algorithms to drive a set of loudspeakers such that the desired signals are correctly reproduced at CPs of different zones.

The system may contain at least two headrest loudspeakers per car seat to deliver sound at low and high frequencies, and an optional subwoofer to deliver the sub frequency range. For better SFC, the system can comprise full-range headrest loudspeakers along with door woofers, mids and tweeters, and A- and B-pillar loudspeakers (or ceiling loudspeakers) capable of delivering high and middle frequencies.

The above is a rough overview of the most common loudspeaker configurations that might be utilized by the approach of the present disclosure, however, the approach of the present disclosure is not restricted to the loudspeaker types or positions described above.

The sound reproduction system comprises a signal chain that reproduces the specific zonal audio signals at each of the specified zonal CPs. The reproduction system comprises the entire signal chain including signal processing, computation/modification/filtering of the input audio, then defining a set of loudspeaker signals that will lead to the reproduction of the desired pressure at the CPs. The full process is made adaptive to listener positions such that the loudspeaker signals are adapted in real-time based on the most recent listener position, provided by an appropriate head tracking system (for example, a camera or infrared sensors).

The control method may consist of a number of approaches, for example but not limited to:
Inverse filtering (also known as Pressure Matching (PM) [A], least-squares inversion, crosstalk cancellation, transaural processing, least-squares beamforming, weighted pressure matching);
Acoustic contrast control (ACC) [D];
Beamforming;
Energy Difference Maximisation (EDM) [D];
Amplitude panning;
Delay panning.

Some of these reproduction methods require knowledge of the acoustical TFs describing the acoustical path from each loudspeaker to each CP. Such TFs may be based on acoustical models (and thus called “model TFs” or “modelled TFs”) of the system or measurements, including any relevant processing to make measured data more usable in the algorithm, or adaptation of modelled data through empirical measurements to be closer to the in-situ true transfer function. In the latter case, they are called “measured TFs” or “TFs from a database/dataset” or “pre-stored TFs.”

User (head) tracking can be integrated into all parts of the system to provide consistent and accurate sound reproduction for each listener. Additionally, the use of head tracking avoids having to detune or compromise the system to work across a wide area where the listener might be positioned—the system places effort only in controlling the exact locations of the listeners' ears.

### SFC Algorithm Overview

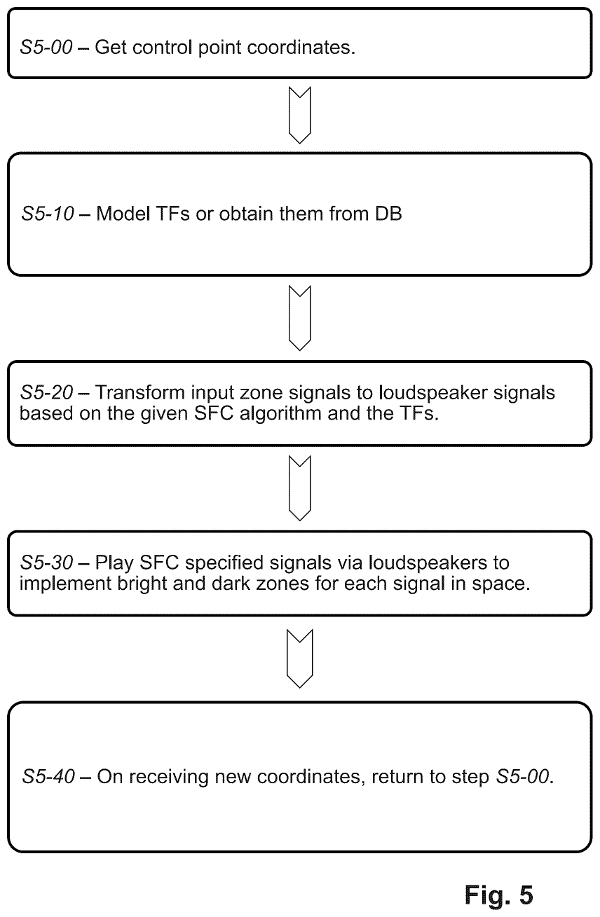

After generating zonal signals at the Mixing Stage, SFC is performed generally in the following way (see also FIG. 5):
1. The SFC algorithm requests user positions (or reads them from a message queue, or CPU registers, or from anything else depending on the specific implementation). The user position(s) are required as the CP positions for each zone are defined by the coordinates of listeners' heads. See for example FIG. 9, where CPs are located around listeners' ears. On receiving the user position, the algorithm calculates the desired CP positions (S5-00).
2. Provided with the CP coordinates, the SFC algorithm requires the TFs from each loudspeaker to each CP position (S5-10). This may be achieved by modelling the TFS, or by retrieving measured TFs from a dataset. Typically, datasets hold TFs for certain sets of measured positions. As target CPs may often occur in between the measured positions, the SFC algorithm performs linear, or Lagrange, or some other type of interpolation of the known TFs from a dataset to obtain the unknown one.
3. The goal of the SFC algorithm is to generate loudspeaker signals, which combine at the different listening zones such that the Mixing Stage signals get delivered to the target CPs (bright zones) while getting suppressed in all the other (non-target) CPs (corresponding to dark zones). Thus, the SFC algorithm is applied to the Mixing Stage signals frame-by-frame to create loudspeaker signals to achieve this effect (S5-20). The SFC algorithm uses knowledge of the TFs in this processing.
4. The processed Mixing Stage signal frames get reproduced via loudspeakers (S5-30).
5. As TFs change when listeners move (which changes the corresponding zonal CP positions), the SFC algorithms need to be updated accordingly every time a position change is detected (S5-40).

### Selected Contributions

Unlike in other approaches, the crossover frequencies of the system of the present disclosure (consisting of multiple subbands of frequency operation for different SFC algorithms) are not conditioned by the chosen types and positions of loudspeakers, that is, acoustic restrictions due to the hardware. In the present disclosure, the different crossovers are selected depending on the practical utilization range of certain SFC algorithms based on analysis of the system within a car cabin. Specifically, the suggested frequency subbands are defined by the geometrical constraints of a car cabin, interference patterns at different frequencies inside the cabin, average distances between listeners at different seats, and the average human head size.

The approach of the present disclosures involves a flexible (adjustable) combination of subbands, the SFC algorithms within them, the definition of the control zones handled by each SFC algorithm, different approaches of handling the TFs used by the algorithms, and having the head tracking subsystem optionally On or Off in different subbands. This combination is self-consistent due to the interplay between the above-mentioned spatial (geometrical) scales.

Another contribution is that loudspeaker sets used for sound reproduction are not supposed to be strictly bound to the mentioned subbands as often implied in other approaches. In other words, any loudspeaker can be used by one or more SFC algorithms.

The approach of the present disclosure also involves a robust method for obtaining measured TFs and treating them differently for different subbands. The method is based on the idea of irregular space sampling, which invalidates the requirement of precise positioning of measurement microphones at pre-defined coordinates in space. During the operational phase, the irregular set (grid/-cloud) of the measured positions can be used for TF interpolation without using conventional look-up tables which allows for some further optimizations of the TF storage and retrieval routines for SFC algorithms.

Another contribution is a position-dependent switching between measured and modelled TFs for higher frequencies for all given CP and loudspeaker combinations, to optimize the SFC reproduction accuracy.

### Frequency Subbands of Operation

Because of the acoustical properties of a car cabin as well as fixed seat positions in the car and psychoacoustic features, the sound processing is divided into a number of distinct frequency ranges (subbands) using different control methods, types of TFs, and configurations of adaptiveness to achieve optimal control zone separation and high-quality spatial sound in each subband.

In some approaches, signal splitting in subbands is performed based on the free-field considerations of the sound waves. Interference patterns at lower frequencies, and loudspeaker array beamforming or individual loudspeaker directivity at higher frequencies, which can be poor approximations for loudspeakers in real acoustic environments and in the near-field, are used. In contrast, the approach of the present disclosure suggests taking into account the natural strong interaction between the sound field and the car cabin enclosure as well as the natural scales of positioning of the sound signal receivers-human ears-within the sound field interference patterns. There are three main physical scales in a car cabin which define different approaches to SFC, namely:
1. cabin dimensions, which specify the acoustic modes which should be carefully considered to avoid damaging of sound quality due to resonant behaviour of the loudspeakers and the car cabin at different frequencies and different loudspeaker locations in the cabin;
2. typical distance between car seats, which suggests a low-frequency range where bright and dark zones of a car-seat size or a human-head size can be implemented;
3. average distance between human ears, which points at the mid- and high-frequency ranges allowing for robust binaural sound delivering to each person in the car.

Based on the interplay between these scales and some other factors described below, the following subbands are defined which make up the signal processing system of the present disclosure.

### Subband 1—Subwoofer Range

The sub-frequency sound, where the wavelength is larger than the enclosure itself, does not provide an opportunity to perform spatial control, within the dimensions of a typical car cabin. In this first subband, no attempt is made to provide spatial or zoned audio. The subband is either operating for all listening zones equally, or not activated. To specify the upper boundary of the first subband, the first crossover frequency Fₓ₁ (60-100 Hz) should be defined. This frequency may depend on the chosen loudspeaker's characteristics, the enclosure dimensions and the technical specifications of the loudspeaker drivers used for reproduction in the next subband. To avoid contradiction with the above statement about not relying on the properties and positions of loudspeakers, it should be noted that the actual operational range of the presented SFC system starts from the second subband, so Fₓ₁ serves as a boundary condition, the cut-off frequency after which the system is capable of doing SFC.

### Subband 2−—Low Frequency Range

The second subband is considered from Fₓ₁ to the second crossover frequency Fₓ₂ (200-300 Hz), which may vary depending on car cabin dimensions, distances between seats, and interior materials. Fₓ₂ is typically close to such an empirical measure of acoustic enclosures as Schroeder frequency [I]. Below that frequency, the sound field demonstrates strong modal behavior. SFC is possible due to the following main factors:
loudspeakers work in the near-field regime with respect to the desired control zones (long wavelengths, short loudspeaker-to-control point distances), so they can excite sound pressures at frequencies between modal harmonics without excessive effort;
due to the significant lengths of the waves, it is possible to use measured TFs for SFC methods; at the same time it is hard to model TFs without using very complex and computationally expensive finite element analysis schemes, which would also require precise knowledge about all geometry, surfaces and materials of the cabin interior.

In the second subband, because of the long wavelengths, it is challenging to practically implement a significant sound pressure difference (contrast) between ears of one same listener.

In this subband, energy contrast (EC) (e.g., ACC, EDM), or crosstalk cancellation (CTC) (e.g., PM) methods can be utilized. Energy contrast methods (e.g. ACC, EDM) attempt to maximize the difference in reproduced energy between the desired reproduction control point(s) (‘bright’ control points) and all other control points (‘dark’ control points). No attempt is made to reproduce a specific phase at the control points, only the difference in reproduced energy is controlled (absolute value of the pressure squared at the control points). Crosstalk cancellation methods attempt to reproduce a specific pressure (magnitude and phase) at a given target control point(s) and cancel the leakage of the signal (with respect to amplitude) at the other control point(s). Both EC and CTC methods attempt to maximize the difference between bright and dark control points. In EC methods this is done by considering energy (absolute value of the pressure squared) and thus cannot reproduce a target phase signal. In CTC this is done by considering pressure (magnitude and phase). Each of these are appropriate in different frequency regions. At low frequencies, for sound zones contrast is the most important factor, whereas at higher frequencies accurate reproduction of the entire target signal (magnitude and phase) is more important.

The ACC and EDM methods provide significant pressure contrasts between bright and dark zones, but their disadvantage is that they do not preserve phase information of the delivered signal. This could cause issues if sound zones correspond to separate ears of the same listener, whereas an unpredictable phase difference between two listeners (if a zone covers the whole head of a listener) is allowed.

In practice, the achievable acoustic contrast between bright and dark zones in this subband is 15-20 dB, if the zones are separated by a typical distance between car seats of about 60 cm (or 2-5 dB, if the zones correspond to a pair of human ears), which does not allow for comfortable listening to, e.g., different musical tracks, but provides some degree of individualization:
listeners can adjust loudness to their comfortable levels;
music loudness of any single listener can be decreased in order to receive a phone call or listen to prompts of the navigation system without significant leakage to other listeners;
different equalisation curves can be applied in different PSZs.

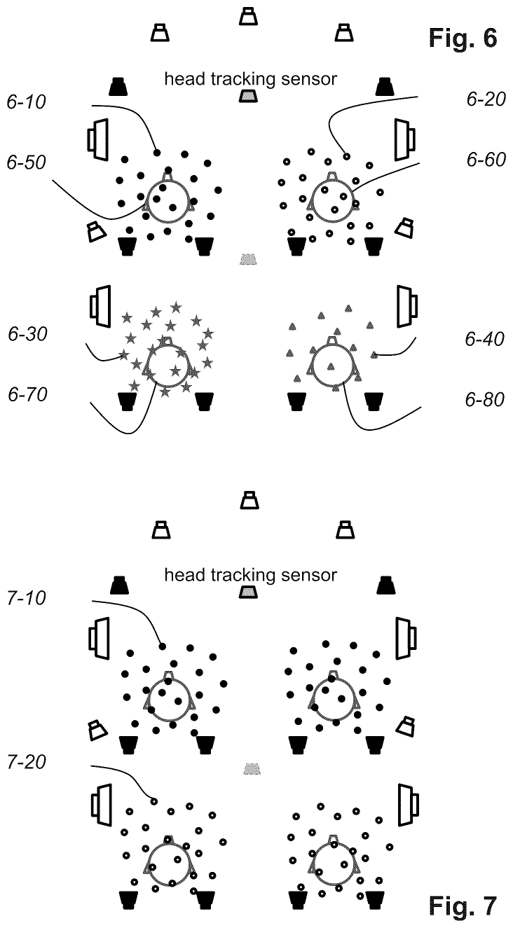

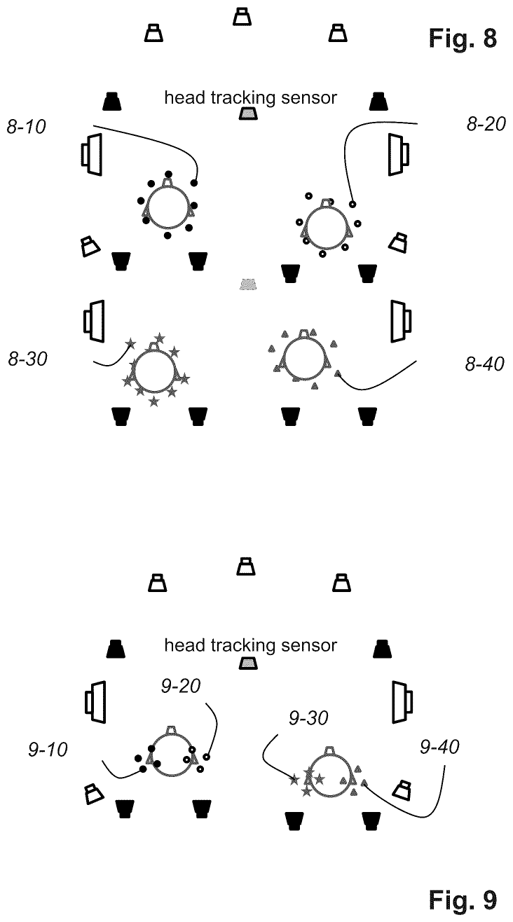

For the head tracking system, there are multiple options of its application in this subband.
1. When head tracking is not available or is intentionally off, then, as depicted in FIG. 6, listening zones can be defined by CPs (6-10, 6-20, 6-30, 6-40 with different CP markers) scattered over seat-size volumes around listener heads (6-50, 6-60, 6-70, 6-80).
In this specific case, the sound is directed to each zone making inter-zone contrast as high as the SFC method allows for given CPs and the distance between zones. The drawback of such an approach is that the chosen SFC method, trying to distribute pressure uniformly across a big volume, generally performs poorly because the acoustic pressure distribution (the interference pattern) is quite complex in the car cabin even at low frequencies.
2. If head tracking is also not available or is turned off, some listeners can be grouped within bigger listening zones therefore decreasing the overall number of zones. For example, those zones can be the front row (7-10) and the rear row (7-20) of the vehicle cabin, as shown in FIG. 7. However, the mentioned drawback will be even worse in such a case.
3. Head-tracking via a non-invasive system, i.e., non-wearable devices, can be enabled for each listener, so the CPs are distributed in the head-size volumes (8-10, 8-20, 8-30, 8-40) around each tracked head, as shown in FIG. 5. This allows for forming interference patterns with higher (bright zone) and lower (dark zone) pressure regions of smaller sizes, which is more natural, in the sense of naturally formed interference patterns in a cabin, and therefore easier to achieve by SFC methods.
Furthermore, if the head tracking is not available or disabled in this subband in order to decrease the required computational power, the head-size bright zone can still be formed to cover the region where the head is situated with higher probability. This region will serve as a sweet spot, providing the best quality of sound. Because this reproduction region is at low frequencies, moving the head a few centimetres away from this region will not significantly affect spatial sound experience, because the majority of the spatial cues are delivered by the higher frequency subbands of the system. The sound image may shift in this case due to disbalance in sound pressure when one of the ears leaves the sweet spot. At the same time, the small enough zone will be preferable for the sake of SFC algorithm performance.
4. Fourth, various combinations of the above options are possible. For example, the head tracking is enabled for the frontal row listeners, while the rear ones are not tracked and belong to one common or two separate non-adaptive control zones, or vice versa.

It should be understood that disabling head tracking makes sense for the purpose of decreasing computational power. Indeed, for a spatially fixed set of CPs there is no need for filter adaptation in an SFC algorithm, which is typically rather greedy as the system comprises multiple loudspeakers, multiple CPs, and has to provide the full-range and high quality sound.

For this subband, door woofers and/or headrest loudspeakers can, for example, be used, as they have the appropriate frequency response.

### Subband 3—Middle Frequency Range

The third subband resides between Fₓ₂ (200-300 Hz) and Fₓ₃ (1000-3000 Hz).
due to the size of the wavelengths in this subband, SFC methods can implement significant acoustic contrast between zones around ears of the same person;
in this frequency region, the input audio content contains significant spatial audio cues, so there should be accurate delivery of both channels of binaural sound to each ear of each listener;
TFs may still be measured in the car cabin with a reasonable effort, sufficient accuracy and robustness (they remain similar across different temperatures, different head and body sizes, different clothes of passengers, and other typical deviations of the cabin interior);
The modal behaviour vanishes, which makes the previous point stronger: TFs are more sensitive to the interior deviations, but there is no need for a very high accuracy because the car cabin no longer exhibits strong modal behaviour.

The SFC method in this subband should allow for delivering precise channel amplitude and phase into a targeted ear of a listener, and thus a CTC algorithm is used. An example is the PM method or the technology in Refs. [E, F].

Accurate delivery of a signal into an ear zone requires accurate tracking of the listener ear positions (see FIG. 9 with ear-attached zones 9-10, 9-20, 9-30, 9-40). So, in general, head tracking should be enabled in this subband. Otherwise, there will be a fixed sweet spot region limited to approximately 2-3 cm from the control points in sense of listener's head movements away from the sweet spot. Nevertheless, the head tracking is still optional.

The TFs used in this subband may be defined as hybrid TFs, composed by the combination of more accurate measurements and less accurate, but more robust, modelled TFs. The frequency where one type of TFs transitions into another one is defined by the distance between each CP and each loudspeaker position.

When a loudspeaker is close to a CP, in general a SFC algorithm will rely more on said loudspeaker to control the given CP. In practice this means the loudspeaker contribution to controlling this CP is much greater than loudspeakers further away. This means inaccuracies in the TF can lead to a significant reduction in the SFC performance. Therefore, in the region where the listener is close to a loudspeaker, measured TFs are more appropriate. Whereas, when the listener is further away from the loudspeakers, modelled TFs are preferable. This defines an adaptive transition frequency per loudspeaker in this subband, which separates measurements at lower frequencies from the model at higher frequencies. The transition frequency is set per loudspeaker and per control point as it depends on the distance from each control point to each loudspeaker, and the frequency of the transition varies as a function of said distance (higher transition frequency for small distances, lower transition frequency for large distances).

One approach to define the transition frequency between measurements and the model can be defined based on a multiplier of the wavelength corresponding to the distance between a CP and a loudspeaker. For example, if the distance (d) is 0.34 m, and the multiplier (α) is set to 4, the transition frequency (Fₜᵣₐₙₛ) will be 4 kHz, which is derived from the following formula:

$${F}_{trans} = α \frac{{c}_{0}}{d} , \qquad ( 1 )$$

where c₀ is a speed of sound.

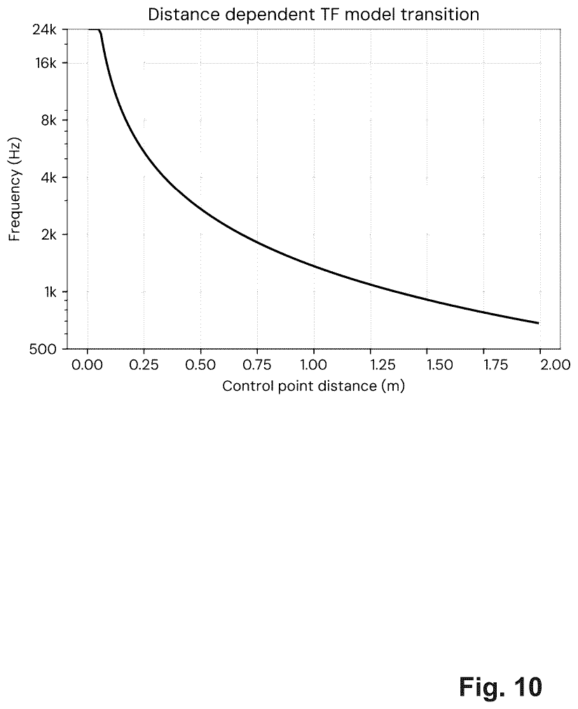

Note, this means that at a given fixed frequency within this subband, some loudspeakers (those which are close to a listener) may use different types of TFs than the other loudspeakers (which are further away). This is also set as a function of zones and CPs. That is, if listener 1 is very close to a given loudspeaker, but listener 2 is far away, then TFs from the loudspeaker to listener 1 will have a higher transition frequency between measurements and the model than between the same loudspeaker and listener 2. This behavior can be easily visualized in FIG. 10 where Eq. (1) is analyzed for a set of distances.

For those skilled in art, it should be obvious that the TF type separation boundary expressed as Eq. (1) and plotted in FIG. 10 is just an example, while many other dependencies are possible, e.g., αc₀d^{β} (for any real β), or α exp (c₀d^{β}), or, in general, ƒ(c₀, d, α, β, γ, . . . ) for any applicable function ƒ( ) and its parameters.

### Subband 4—High Frequency Range

The fourth subband, starting from Fₓ₃ and ending at the natural audible frequency limit of 20-24 kHz (depending on the system sample rate), provides certain difficulties for using measured TFs. Because of the short wavelengths, the SFC method used in this subband might not tolerate position mismatches larger than a few centimeters, therefore, methods based on the modelled transfer functions provide more robustness. PM method or its flavors, such as Ref. [E, F], are utilized in this subband.

Adaptiveness to changes of head positions is also strongly preferred in this subband. Similar to other subbands, without head tracking a fixed listener position can be assumed, however, very small movements away from this assumed position (<3 cm) would lead to a reduction in the spatial perception of the audio.

### Pressure Matching Algorithms

A summary of the operation of pressure matching (PM) algorithms is provided below.

Consider a system in which the spatial coordinates of the L loudspeakers are y₁, . . . , y_{L}, whereas the coordinates of the M control points are x₁, . . . , x_{M}. The matrix S(ω), hereafter referred to as plant matrix, whose element S_{m,l}(ω) is the electro-acoustical transfer function between the l-th loudspeaker and the m-th control point, is expressed as a function of the angular frequency ω. The reproduced sound pressure signals at the M control points, p(ω)=[p₁(ω), . . . , p_{M}(ω)]^{T}, for a given frequency ω are given by p(ω)=S(ω)q(ω), where q(ω) is a vector whose L elements are the loudspeaker signals. These are given by q(ω)=H(ω)d(ω), where d(ω) is a vector whose M elements are the M signals intended to be delivered to the various control points. H(ω) is a complex-valued matrix that represents the effect of the signal processing apparatus, succinctly referred to herein as “filters”. It should be clear though that each element of H(ω) is not necessarily a single filter, but can be the result of a combination of filters, delays, and other signal processing blocks.

In what follows, the dependency of variables on the frequency ω will be dropped to simplify the notation. p is therefore given by:

$$p = SHd \qquad ( 2 )$$

A PM approach to design the filters is to compute H as the (regularized) inverse or pseudo-inverse of matrix S, or of a model of matrix S, that is

$$H = {e}^{- j ω T} {{G}^{H} ( {GG}^{H} + A )}^{- 1} \qquad ( 3 )$$

where matrix G is a model or estimate of the plant matrix S, A is a regularization matrix (for example for Tikhonov regularization), [⋅]\hat{ }H is the complex-transposed (Hermitian) operator, j=√(−1), and T is a modelling delay.

### Summary of Subbands

The subband options provided above are summarized in the below table. Given certain car cabin dimensions and interior configuration/materials, one can determine the crossover frequencies Fₓ₁, Fₓ₂, Fₓ₃, and make the informed decision on the optimal combination for each subband of the
SFC method,
number of zones (and CP configurations in them)
having zones tracked or not,
using modelled or measured TFs,
which combination of loudspeakers to utilise, which can control said number of CPs using the expected available computational resources.

More details and example implementations are provided below.

| Subband | | | | | | | | Zone |
|---|---|---|---|---|---|---|---|---|
| number | Lower freq. | | Upper freq. | | SFC algorithm | TFs | Tracking | definition |
| 1 | 0-20 | Hz | 60-100 | Hz | NA | NA | NA | NA |
| 2 | 60-100 | Hz | 200-300 | Hz | EC (e.g., ACC or EDM), CTC | Measured | Adaptive, | Seat, Head, |
| | | | | | (e.g., PM or Weighted PM) | | non-adaptive | Ears |
| 3 | 200-300 | Hz | 1-3 | kHz | CTC (e.g., PM, Weighted | Measured, modelled, | Adaptive, | Ears |

| | | | | | | | |
|---|---|---|---|---|---|---|---|
| | | | | PM, [E] or [F]) | hybrid | non-adaptive | |
| 4 | 1-3 | kHz | Nyquist frequency/ | CTC (e.g., PM, Weighted | Modelled | Adaptive, | Ears |

| | | |
|---|---|---|
| at least 20 kHz | PM, [E], or [F]) | non-adaptive |

### Transfer Function Measurement Procedure

Knowledge of the TFs between the combinations of loudspeakers and CPs is required by some of the SFC algorithms. In the case where measured TFs are required, the approach of the present disclosure proposes the following approach. The idea is that it is not necessary to measure all possible CP positions. For a given frequency, one can get TF values for positions spaced by some fraction of the wavelength (shorter than the Nyquist limit—half of the wavelength—but preferably even shorter, down to one fourth of the wave [G]) and then perform linear interpolation to obtain TFs in intermediate positions. The TF measurements should be carried out with omnidirectional microphones or with head or head-and-torso simulators.

Traditionally, the TF measurements are suggested to be carried out with microphones positioned in nodes of a regular one-, two-, or three-dimensional grid. Such an approach is accompanied by various difficulties because of the lack of reliable markers inside a modern car cabin, namely, everything inside is curved, uneven, asymmetric, shifted, etc. It is not easy to fix a microphone at a pre-defined desired location. In the present disclosure, irregular positioning of the microphones is described for the measurement procedure.

First, the microphones are fixed in position. Even if the intended positions are organised as an evenly sampled regular grid, there is no need for positioning microphones precisely. That is why the positioning is referred to as “irregular.”

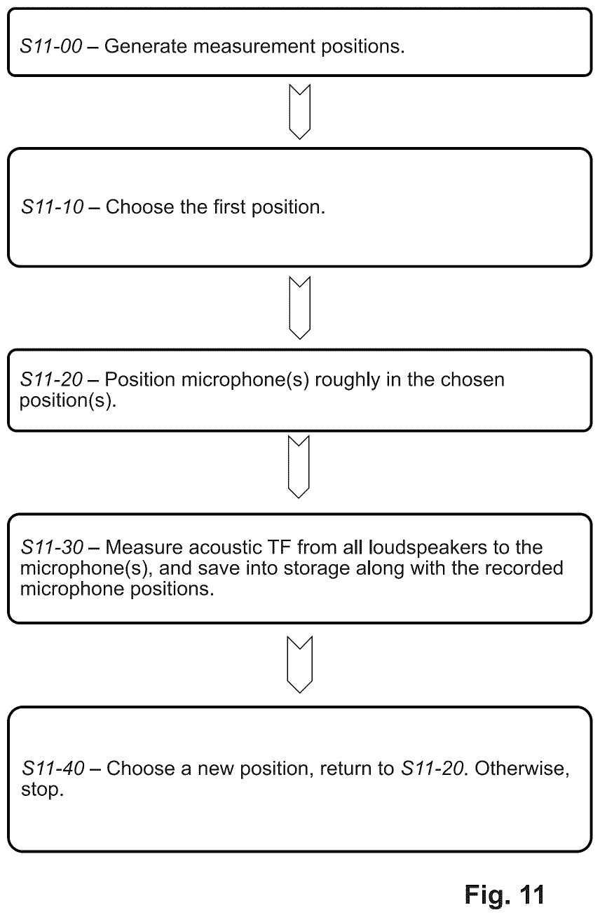

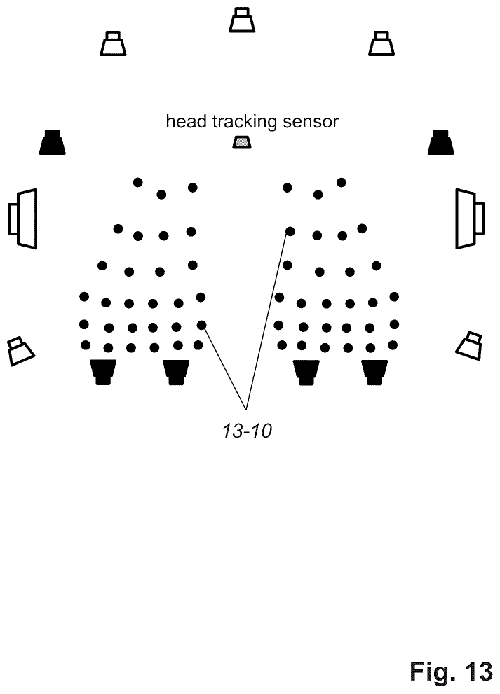

Then, recording of the loudspeaker to microphone (CP) TFs is performed and they are saved along with the microphone positions into a dataset. Thus, a cloud of measured positions is obtained. The measurement procedure is shown in FIG. 11 and the exemplary measurement positions (13-10) are shown in FIG. 13 and discussed below.

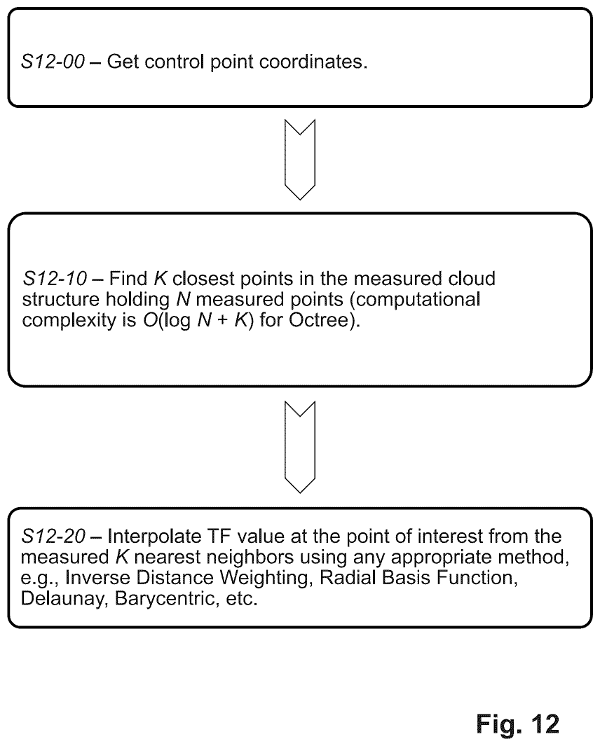

This cloud can be transformed then into a compact data structure, for example (but not limited to), Octree [H], and then used to interpolate TF values at arbitrary positions in space using some interpolating algorithm (IDW [J], RBF [K], Delaunay [C], Barycentric [B], etc.) as shown in FIG. 12.

This method does not use conventional look-up tables and allows for two immediate optimizations:
1. The passenger's head in a car takes some positions with higher probabilities than the others. Therefore, to speed up measurements and decrease storage space requirements for the data structure, the generated measurement points (S11-00) are denser around the highly probable head positions and sparser in the regions of rare head presence.
2. The measured point cloud can be down-sampled in accordance with the wavelengths of the acoustic field: the longer the wave, the wider the space which can be left empty between the measurement points to still smoothly interpolate TFs.
   (a) This means different grid densities (the spacings between the TF measurement positions) can vary depending on the subband (less dense for low frequencies, highly dense for high frequencies).

### Separate Subband Processing

According to one implementation of the approach of the present disclosure, the subbands can be implemented as separate modules (FIG. 2A). FIG. 2A shows an example of delivering two binaural signals to two listeners, where each SFC algorithm and its filters work within a dedicated frequency subband. This approach provides the possibility, but not the requirement, of running subband processing on different DSP systems (different SoCs, different CPU cores, etc.). The advantage is flexibility, but the disadvantage is the need to synchronize those separate devices.

In FIG. 2A, two 2-channel signals (2A-10, 2A-20) for the left and right ears of listener 1 and listener 2, respectively, produced by the Mixing Stage (3-10), are supposed to be delivered to two listeners (2A-30, 2A-40). The subwoofer signal (2A-50), produced at the Mixing Stage as well, is played via subwoofer(s) (2A-60) to the whole car cabin (2A-70) without SFC processing.

Four full-range input channels get filtered via three band-pass filters (2A-80) for the subbands 2, 3, and 4, respectively, and processed by the corresponding SFC modules (2A-90), which receive listener coordinates from the head tracking system (2A-100) to adjust processing parameters.

The second subband signals (2A-110, 2A-120) for PSZs of the listeners (2A-30, 2A-40) are generated to be reproduced via the loudspeakers (2A-130). The SFC modules of subbands 3 and 4 generate loudspeaker signals for the left ear of one listener (2A-30), which get summed up (2A-140) and reproduced via the loudspeakers (2A-130). In a similar way, they generate signals for the rest of the three ears of the listeners.

Processing Subbands within a Common Signal Flow

According to another implementation of the system, the SFC methods of each subband can be combined and implemented using a common signal flow (FIG. 2B). FIG. 2B shows an example of delivering two binaural signals to two listeners, where the signal filtering is performed in the full frequency range by a common DSP signal flow, but with the same splitting of SFC algorithms into subbands. That is, one signal flow (consisting of normal audio DSP operations such as IIRs, FIRs, delays or gains) for all subbands where frequency dependent elements within said signal flow are created by merging the different subband SFC algorithms (with the cut-off frequencies Fₓ₁, Fₓ₂, Fₓ₃), and then applying to the full-range signal.

An example in FIG. 2B shows an implementation where all SFC algorithms are implemented using one DSP system which processes all frequencies within one signal flow, as opposed to separating into separate signal flows for each subband. Again, two 2-channel signals (2B-10, 2B-20) for the left and right ears of listener 1 and 2 repetitively and one subwoofer signal (2B-30) are supposed to be delivered to two listeners (2B-40, 2B-50). The subwoofer signal is played to the whole car cabin (2B-60) via subwoofer(s) (2B-70) without SFC.

The binaural signals get processed by the common DSP system (2B-80), which generates specific loudspeakers signals which, when summed at the listener ear positions, will deliver dedicated sound channels to left ear zones (2B-90), right ear zones (2B-100), and head- or seat-size zones (2B-110). Coefficients, which the DSP system operates with, incorporate all subband coefficients generated by the subband SFC algorithms (2B-120) adjusting their parameters in accordance with the input from the head tracking system (2B-130).

### Loudspeaker Placement and Usage Across Subbands

Except for the subwoofer (20 Hz-Fₓ₁), any loudspeaker may belong to one or more subbands of the system. This differs from alternatives approaches where unique speakers are used for unique processing subbands. There is typically only one subwoofer in most of the cars where it is even installed. In high-end cars, a few subwoofers can be installed and tuned to minimize spatial variability of sound loudness due to the domination of cabin modes. The approach of the present disclosure is not limited to only one subwoofer and other existing and standardized processing to improve the subwoofer response in subband 1, the key distinction of which is that the subwoofer subband does not utilize an SFC algorithm.

Except for subwoofer(s), there are typically three types of loudspeakers being installed in cars:
woofers (60 Hz-3 kHz),
midrange (200 Hz-7 kHz),
tweeters (2 kHz-22 kHz).

Common configurations of these loudspeakers can be employed in the approach of the present disclosure in the following way:
At least 4 door woofers can be used in the second subband to control seat-size or head-size control zones. Mathematically, at least 4 woofers are needed to implement 4 PSZs (assuming 4 listeners) each having one CP. For a bigger number of CPs, an SFC algorithm will have to solve the underdetermined problem (more sound receivers than sound sources [A]). Thus 4 woofers satisfy the minimum required quantity of transducers for the second subband. When increasing the number of CPs to two per PSZ (two ears of the same listener), 4 woofers can still work within the underdetermined SFC, and this will not ruin sound quality due to the close proximity of CPs to each other with respect to the wavelengths. However, the general recommendation will be to have at least as many transducers as there are CPs per subband.
At least 4 midrange loudspeakers, which are also often installed in the doors, fit well the third subband, which can also be reproduced by the woofers considered above. Thus, the woofers may work in subbands 2 and 3, implementing 4 PSZs at low frequencies and helping to achieve the minimum loudspeaker count requirement in subband 3, where at least 8 CPs for 8 control zones (ears) are supposed to be targeted.
At least 4 tweeters in the A- and B-pillars, assisted by 4 midrange loudspeakers, suit well the lower frequency part of subband 4 (up to the upper operational frequency of the midrange loudspeakers).

For better SFC, it is preferable also to have full-range headrest speakers, which can work across all three (#2, #3, and #4) subbands providing high-accuracy control due to close proximity to the ears. They can go low in frequency because of the near-field regime and they are not shadowed by seats and heads/bodies of other passengers. A good example of such loudspeakers is Balanced Mode Radiators, which are practically full-range in frequency and, due to small dimensions, can fit well in headrests as well as in A- and B-pillars, dashboards, and other small-scale parts of the car interior attractive for loudspeaker placement.

In general, as the considered SFC algorithms work in frequency domain, each frequency bin can use as many loudspeakers as available with the following constraints:
1. a loudspeaker does not produce excessive harmonic distortion at this frequency,
2. the number of loudspeakers with respect to the number of CPs provides an acceptable balance between the level of SFC and the required computational power to perform SFC.

### Example of Transfer Function Measurement/Interpolation Positions

One example of the TF measurement method relates to loudspeaker configurations including headrest speakers. The headrest speakers are very close to the ears in this case, and it is very important to have accurate control of the sound field handling head rotations and translations in the near-field to avoid explicit spotting of sound sources behind and close to the head by a listener instead of sensing the whole acoustic image.

The irregular grid of positions in this case will be dense and wide in the close proximity to the headrest, being sparser and narrower when moving away in the forward direction.

As discussed above, the grid does not have to be regular, but the minimum average distance between the measurement points will define Fₓ₃, i.e., the highest frequency at which SFC can provide the best sound quality with the measured TFs. For example, if Fₓ₃=3 kHz with the wavelength of about 11 cm, then the longest distance between measurement positions should preferably not be longer than 2.5 cm (quarter of the wavelength) to not compromise the SFC algorithm accuracy.

In FIG. 13, the 2D example of TF measurement positions is shown. The main assumption is that the listeners' heads will be most of the time close to the headrests. Another assumption relating to the view angle of the head tracking system when a head is too close to it, is that the head is not well-tracked at extreme angles, so there is no sense in measuring TFs at those positions.

The depicted measurement positions correspond to the center of the head, if measurements are performed by a Head- or Head-And-Torso Simulator (HATS). In case of measurements with standalone microphones, they should be placed in corresponding positions, which are on the left and on the right from the presented ones.

For a 3D cloud of measurement positions, the same “flat” set of points can just be repeated at different layers along the vertical directions with the similar assumptions in mind:
denser where a head spends most of the time,
sparser where it spends less time or where it is not seen well by the tracking system.

Sound quality will degrade if a listener positions their head at a sparsely measured region of space, but there can always be some kind of trade-off between the system coverage and the computer storage requirements to store the measured TF data.

### Examples of the Present Disclosure

Examples of the present disclosure are set out in the following items.

As a first item, a system for a car to reproduce individualized sound to one or more listeners. The components of this system are
(a) An input mixing stage used to combine any number of given input signals to define the specific signals to be reproduced in each zone.
(b) A processing module which uses a combination of SFC algorithms, knowledge of the reproduction system and environment and 4 frequency subbands of processing to define loudspeaker signals to reproduce the above desired zone signals. Each algorithm is assigned to a subband based on the suitability of that algorithm to work in the particular subband.
(c) A characterised distribution of loudspeakers within the car cabin
(d) A head tracking system used to adapt the SFC algorithm to ensure correct reproduction based on the listener's given instantaneous positions

As a second item, the manner in which the SFC algorithms for the 4 subbands may be applied using two different signal processing implementations-within the SFC processing module:
(a) Option 1 where
   i. The zone signals are split into the 4 frequency ranges as specified by the subbands
   ii. Processed individually using the specified SFC algorithm for each subband, creating a set of loudspeaker signals in a limited frequency range iii. The final loudspeaker signals are defined by appropriately summing the output of each frequency band-limited SFC algorithm, noting any given loudspeaker may belong to any given subband (a single or multiple subbands).
(b) Option 2 where
   i. The zone signals are processed for all frequencies with one common signal processing implementation to apply all SFC methods for all frequencies at the same time, resulting immediately in the final loudspeaker signals to be played back by the loudspeaker distribution
   ii. Where the above signal processing blocks (e.g. FIRs, IIRs, biquads, gains, delays) are specified to include the frequency dependence of the 4 subband approaches by defining the coefficients for each signal processing block appropriately.

As a third item, the type of TF used in subband 3 depends on the distance between each CP and each loudspeaker. This can be adapted in real time based on information of listener position. Measured TFs are used at lower frequencies (more accuracy) and modelled TFs at higher frequencies (more robustness). When a CP is closer to a loudspeaker the transition frequency between these two types of TFs is raised. When the distance is larger, the transition is lowered.

As a fourth item, using an irregular sampling grid for measuring TFs and characterizing the car, then using a minimized/sparse storage data structure, and:
(a) In subbands 2 and 3, knowledge of the car is that in this frequency range, measurements of the car (not models) should be used, however an interpolation approach of a sparse irregular grid can be used. Pure TFs from a lookup table are not needed.
(b) Density of the grid may change to give higher accuracy in certain regions, depending on
   i. Analysed probability of listener position in a car cabin
   ii. Frequency operating range.

The 4 subbands may operate as follows:
(a) In the first subband (subwoofer range), no attempt is made to perform SFC; the frequency range is from 20 Hz to 60-100 Hz;
(b) In the second subband,
   i. Frequency range: from 60-100 Hz to 200-300 Hz, should be found in general around the Schroeder frequency of a certain car cabin,
   ii. SFC algorithms: ACC, EDM, PM, Weighted PM,
   iii. Zone/CP definition: a zone will typically correspond to a human head size; the simplest way to define it is to put two CPs at the ear positions. Zones can also correspond to individual ears and be defined by a single CP at each ear or multiple CPs around each ear.
   iv. Transfer functions: Measured
   v. Loudspeakers used: door woofers, midrange loudspeakers for corresponding sub-range of the frequencies, wide- or full-range headrest speakers,
   vi. TF Grid density: maximum 25 cm between the points in the most dense part of the cloud of measurement points (as a quarter of about 1 m wavelength at 300 Hz).
   vii. Target signal from the Mixing Stage: the same 1-channel signal for all CPs of the same listener, if using ACC or EDM methods, or 2-channel signal targeting left and right ear zones independently for each listener, if using (weighted) PM method;
(c) In the third subband,
   i. Frequency range: from 200-300 Hz to 1-3 kHz.
   ii. SFC algorithms: PM, weighted PM, modified PM [E, F].
   iii. Zone/CP definition: a control zone corresponds to a listener's ear, can be at least one CP at the ear position or multiple CPs around the ear.
   iv. Transfer functions: Measured or modelled based on loudspeaker and CP positions, or a mixture of pre-stored and modelled TFs.
   v. Position-dependent transition for TFs—the method of mixing measured and modelled TFs based on CP to loudspeaker distance
   vi. Loudspeakers used: midrange loudspeakers, tweeters, headrest speakers.
   vii. TF Grid density: maximum one quarter of a wavelength of Fₓ₃ in the most dense region of the cloud of measurement points.
   viii. Target signal from the Mixing Stage: 2-channel signal targeting left and right ear zones independently for each listener.
(d) In the fourth subband,
   i. Frequency range: from 1-3 kHz to 20-22 kHz.
   ii. SFC algorithms: PM, weighted PM, modified PM [E, F].
   iii. Zone/CP definition: same as in the third subband.
   iv. Transfer functions: modelled.
   v. Loudspeakers used: midrange loudspeakers, tweeters, headrest speakers.
   vi. Target signal from the Mixing Stage: 2-channel signal targeting left and right ear zones independently for each listener.

The motivation for the subband frequency ranges and loudspeaker distributions (noting how one loudspeaker can belong to one or multiple subbands) is based on
i. The geometrical constraints of the car cabin,
ii. The distance between CP and loudspeaker
iii. The performance and capabilities of the sound-field control methods
iv. Individual characteristics of loudspeakers

### Alternative Implementations of the Present Approaches

It will be appreciated that the above approaches can be implemented in many ways. There follows a general description of features which are common to many implementations of the above approaches. It will of course be understood that, unless indicated otherwise, any of the features of the above approaches may be combined with any of the common features listed below.

There is provided a computer-implemented method.

The method may be a method of generating audio signals for an array of loudspeakers (e.g., a line array of L loudspeakers).

The array of loudspeakers may be positioned in an acoustic environment (or ‘acoustic space’, or ‘listening environment’).

The audio signals are generated in a plurality of frequency bands.

The method may comprise obtaining (or receiving, or determining) the plurality of frequency bands.

The method comprises receiving at least one, or a plurality of, input audio signals [e.g., d].

Each of the plurality of input audio signals may be to be reproduced, by the array, in an acoustic environment.

Each of the plurality of input audio signals may comprise a sub-signal in each of the plurality of frequency bands.

Each of the sub-signals in at least one of the plurality of frequency bands may be to be reproduced at a respective subset of a set of control points (CPS) [e.g., x₁, . . . , x_{M}∈ [symbol] ³].

Each of the sub-signals in at least one of the plurality of frequency bands may be to be selectively reproduced at a respective subset of a set of control points (CPs) [e.g., x₁, . . . , x_{M}∈ [symbol] ³].

Each of the respective subsets of the set of CPs may comprise one or more CPs.

Each of the sub-signals in at least one of the plurality of frequency bands may be to be reproduced throughout the acoustic environment.

The plurality of input audio signals may comprise a first input audio signal and a second input audio signal, and the second input audio signal may be an equalized version of the first input audio signal.

The method may comprise receiving position information indicative of a position of each of a mobile subset of the set of CPs.

The mobile subset of the set of CPs may comprise one or more CPs.

The position of each of the CPs may be with respect to the array of loudspeakers.

The position information may be based on a signal captured by a sensor (e.g., an image sensor) and/or a user-detection-and-tracking system.

The image sensor, or each of the plurality of image sensors, may be a visible light sensor (i.e., a conventional, or non-infrared sensor), an infrared sensor, an ultrasonic sensor, an extremely high frequency (EHF) sensor (or ‘mmWave sensor’), or a LiDAR sensor.

The method may comprise selecting a respective SFC mode for each of the plurality of frequency bands.

The selecting may be from a set of predetermined Sound Field Control, SFC, modes.

The selecting may be based on the position information.

Each of the SFC modes may be different.

At least one of the SFC modes may be different from at least one other SFC mode.

The method may comprise generating a respective output audio signal [e.g., Hd or q] for each of the loudspeakers in the array by applying, for each of the plurality of frequency bands, an SFC algorithm corresponding to the SFC mode selected for the frequency band to the sub-signals of the frequency band.

The output audio signals may be generated by applying a set of filters [e.g., H] to the plurality of input audio signals [e.g., d].

The set of filters may be digital filters. The set of filters may be applied in the frequency domain.

The set of filters [e.g., H] may be time-varying. Alternatively, the set of filters [e.g., H] may be fixed or time-invariant, e.g., when listener positions and head orientations are considered to be relatively static.

The set of filters may be based on a plurality of filter elements [e.g., G] comprising a respective filter element for each of the CPs and loudspeakers.

A filter element may be a weight of a filter. A plurality of filter elements may be any set of filter weights. A filter element may be any component of a weight of a filter. A plurality of filter elements may be a plurality of components of respective weights of a filter.

Each one of the plurality of filter elements [e.g., G] may be a frequency-independent delay-gain element [e.g., G_{m,l}=e^{-jωτ(x}^{ₘ}^{,y}^{ₗ}⁾g_{m,l}].

Each one of the plurality of filter elements [e.g., G] may comprise a delay term [e.g., e^{-j∫Σ(x}^{ₘ}^{,y}^{ₗ}⁾] and/or a gain term [e.g., g_{m,l}] that is based on the relative position [e.g., xₘ] of one of the control points and one of the loudspeakers [e.g., yₗ].

Each one of the plurality of filter elements [e.g., G] may comprise an approximation of a respective transfer function [e.g., S_{m,l}(ω)] between an audio signal applied to a respective one of the loudspeakers and an audio signal received at a respective one of the control points from the respective one of the loudspeakers.

The set of filters or the first subset of filters [e.g., [GG^{H}]⁻¹] may be determined based on an inverse of a matrix [e.g., [GG^{H}]] containing the plurality of filter elements [e.g., G].

The matrix [e.g., [GG^{H}]] containing the plurality of filter elements [e.g., G] may be regularised prior to being inverted [e.g., by regularisation matrix A].

The set of filters may be determined based on:
in the frequency domain, a product of the or a matrix [e.g., G^{H}] containing the plurality of filter elements [e.g., G] and the inverse of the or a matrix [e.g., [GG^{H}]] containing the plurality of filter elements [e.g., G]; or
an equivalent operation in the time domain.

The set of filters may be determined using an optimization technique.

The method may further comprise receiving the set of filters [e.g., H], e.g., from another processing device, or from a filter determining module. The method may further comprise determining the set of filters [e.g., H].

The method may further comprise determining any of the variables listed herein. These variables may be determined using any of the equations set out herein.

The output audio signal for a particular loudspeaker in the array of loudspeakers may be based on each of the plurality of input audio signals.

The plurality of frequency bands may comprise at least one of a first, a second, a third, or a fourth frequency band.

The plurality of frequency bands may consist of a first band, a second band, a third band and a fourth band.

The SFC mode selected for the first frequency band may be a control-point-position-independent mode.

The SFC mode selected for at least one of the second, third or fourth frequency bands may be a respective control-point-position-dependent mode and may use a set of transfer functions, TFs.

Each TF may be between an audio signal applied to a respective one of the loudspeakers and an audio signal received at a respective one of the CPs of the set of CPs from the respective one of the loudspeakers.

The set of TFs used in the SFC mode selected for the second frequency band may be a set of measured TFs.

The set of TFs used in the SFC mode selected for the third frequency band may comprise at least one of a set of measured TFs or a set of modelled TFs.

The set of TFs used in the SFC mode selected for at least one of the second frequency band or the third frequency band may be interpolated from a set of measured TFs.

The SFC mode selected for at least one of the second frequency band or the third frequency band may determine a set of CPs closest to (or within a predetermined distance of) the positions of each of the set of CPs for which a measured TF is available, and use the measured TFs for the set of closest CPs.

The set of TFs used in the SFC mode selected for the fourth frequency band may be a set of modelled TFs.

The set of TFs used in the SFC mode selected for the third frequency band may comprise a set of hybrid measured and modelled TFs.

A first part of each of the hybrid measured and modelled TFs, at frequencies below a transition frequency within the third frequency band, may be measured.

A second part of each of the hybrid measured and modelled TF, at frequencies above the transition frequency, may be modelled.

The transition frequency may be specific to each of the loudspeakers and each of the CPs and may be based on a respective distance between the loudspeaker and the CP.

The transition frequency may be inversely proportional to the respective distance.

A first transition frequency for a first loudspeaker and a first CP may be based on a first distance between the first loudspeaker and the first CP.

A second transition frequency for a second loudspeaker and a second CP may be based on a second distance between the second loudspeaker and the second CP.

The first transition frequency may be higher than the second transition frequency, and the first distance may be smaller than the second distance.

The selecting of the SFC mode for the third frequency band may comprise selecting, for each of the loudspeakers and each of the respective subsets of the set of CPs for the third frequency band and based on a respective distance between the loudspeaker and the CP, one of a first SFC sub-mode that uses a set of measured TFs and a second SFC sub-mode that uses a set of modelled TFs.

The selecting of the one of the first or second SFC sub-modes may comprise selecting the second SFC sub-mode responsive to determining that the distance is above a threshold distance.

The modelled TFs may be based on a free-field acoustic propagation model and/or a point-source acoustic propagation model.

The modelled TFs may account for one or more of reflections, refraction, diffraction or scattering of sound in the acoustic environment. The modelled TFs may alternatively or additionally account for scattering from a head of one or more listeners. The modelled TFs may alternatively or additionally account for one or more of a frequency response of each of the loudspeakers or a directivity pattern of each of the loudspeakers.

The modelled TFs may be based on one or more head-related transfer functions, HRTFs. The one or more HRTFs may be measured HRTFs. The one or more HRTFs may be simulated HRTFs. The one or more HRTFs may be determined using a boundary element model of a head.

Each of the TFs of the set of TFs or the set of measured TFs may be measured at a respective CP of a sampling grid having a given density.

The given density may not be uniform across the sampling grid.

The sampling grid may be more dense around an expected position of a head and/or an ear of each of one or more listeners.

The given density may be frequency-dependent.

The sampling grid may have a respective given density for each of the plurality of frequency bands.

The given density for a particular frequency band may be based on at least one of a lower limit or an upper limit of the particular frequency band.

The given density for the second frequency band may be lower than the given density for the third frequency band.

The given density for the second frequency band may have a peak of at most 25 cm between adjacent CPs of the sampling grid.

The given density for the third frequency band may have a peak of at most one quarter of a wavelength of an upper limit of the third frequency band between adjacent CPs of the sampling grid.

The first frequency band may be lower than at least one of the second frequency band, the third frequency band or the fourth frequency band.

The second frequency band may be lower than at least one of the third frequency band or the fourth frequency band.

The third frequency band may be lower than the fourth frequency band.

The second frequency band may be higher than the first frequency band.

The third frequency band may be higher than at least one of the first frequency band or the second frequency band.

The fourth frequency band may be higher than at least one of the first frequency band, the second frequency band or the third frequency band.

A first band may be said to be lower than a second band when at least a lower limit of the first band is lower than a lower limit of the second band.

A first band may be said to be higher than a second band when at least an upper limit of the first band is higher than an upper limit of the second band.

A lower limit of the first frequency band may be at most 20 Hz.

An upper limit of the first frequency band may be between 60 and 100 Hz.

A lower limit of the second frequency band may be between 60 and 100 Hz.

An upper limit of the second frequency band may be between 200 and 300 Hz.

A lower limit of the third frequency band may be between 200 and 300 Hz.

An upper limit of the third frequency band may be between 1 and 3 kHz.

A lower limit of the fourth frequency band may be between 1 and 3 kHz.

An upper limit of the fourth frequency band may be at least 20 kHz.

The SFC algorithm corresponding to the SFC mode for the second frequency band may be one of an energy contrast SFC algorithm or a crosstalk cancellation SFC algorithm.

The SFC algorithm corresponding to the SFC modes for the third and/or fourth frequency bands may be a crosstalk cancellation SFC algorithm.

An energy contrast SFC algorithm may be configured to increase (e.g., maximize) the energy of a given input audio signal reproduced at at least one CP of the set of CPs relative to the energy of the given input audio signal reproduced at the other CPs of the set of CPs.

A crosstalk cancellation SFC algorithm may be configured to reproduce a magnitude and phase of a given input audio signal at at least one CP of the set of CPs and to cancel leakage of the given input signal at the other CPs of the set of CPs.

In the second frequency band, the respective subsets of the set of CPs are at or around a head of at least one listener.

In at least one of the second, third or fourth frequency bands, the respective subsets of the set of CPs are at or around an ear of at least one listener.

The position information may be received from a head tracking system for tracking head movements of one or more listeners.

The acoustic environment may be a vehicle, such as a car.

The frequency bands may be determined based on a geometry of the vehicle.

The method may comprise receiving a plurality of source audio signals.

The plurality of source audio signals may be received from a plurality of respective sources.

Each of the plurality of source audio signals may be different.

The plurality of input audio signals may be determined based on the plurality of source audio signals.

At least one of the plurality of source audio signals may be different from at least one other one of the plurality of source audio signals.

At least two of the plurality of input audio signals may be determined based on a same source audio signal.

At least one of the plurality of input audio signals may be determined based on two or more of the plurality of source audio signals.

The set of CPs may comprise a static subset.

The position of the static subset of the set of CPs may be predetermined. The selecting may be further based on the predetermined positions of each CP of the static subset of the set of CPs.

The set of CPs, or the mobile subset of the set of CPs, may comprise CPs at or around a head of at least one listener.

The set of CPs, or the mobile subset of the set of CPs, may comprise CPs at or around an ear of at least one listener.

The respective subset of the set of CPs for a first one of the plurality of input audio signals in a first one of the plurality of frequency bands may be different from the respective subset of the set of CPs for the first one of the plurality of input audio signals in a second one of the plurality of frequency bands. In other words, the respective subsets of CPs may be specific to each of the plurality of frequency bands.

The respective subset of the set of CPs for a first one of the plurality of input audio signals in one of the second, third or fourth frequency bands may be different from the respective subset of the set of CPs for the first one of the plurality of input audio signals in another one of the plurality of frequency bands.

The respective subset of the set of CPs for a third one of the plurality of input audio signals in a third one of the plurality of frequency bands may be different from the respective subset of the set of CPs for a fourth one of the plurality of input audio signals in the third one of the plurality of frequency bands. In other words, the respective subsets of CPs may be specific to each of the plurality of input audio signals.

The output audio signal for a given loudspeaker in the array may comprise a respective output sub-signal in at least one of the plurality of frequency bands.

The output audio signal for a given loudspeaker in the array may comprise a respective output sub-signal in at least two of the plurality of frequency bands.

The output audio signal for a given loudspeaker in the array may comprise a respective output sub-signal in each of the plurality of frequency bands.

The method may comprise, subsequent to the receiving of the plurality of input audio signals, separating each input audio signal of the plurality of input audio signals into the sub-signals in each of the plurality of frequency bands.

Applying the SFC algorithm may comprise applying, to each one of the sub-signals and separately from the other sub-signals, the SFC algorithm to yield, for each of the loudspeakers, a respective output sub-signal in at least one of the plurality of frequency bands.

The method may comprise combining, for each of the loudspeakers, the respective output sub-signals from the at least one of the plurality of frequency bands to yield the respective output audio signal.

The applying may comprise generating, based on the SFC algorithms corresponding to the SFC modes selected for each of the plurality of frequency bands, a common set of digital signal processing, DSP, coefficients.

The applying may comprise applying the common set of DSP coefficients to the plurality of input audio signals to yield the respective output audio signal for each of the loudspeakers.

The method may further comprise outputting the output audio signals [e.g., Hd or q] to the array of loudspeakers.

The receiving of the plurality of input audio signals may be at a first time, the receiving of the position information may be at a second time, the selecting may be at a third time, and the generating may be at a fourth time. The method may further comprise:
at a fifth time, receiving another plurality of input audio signals;
at a sixth time, receiving position information indicative of a position of each of the mobile subset of the set of CPs;
at a seventh time, repeating the selecting based on the position information received at the sixth time;
at an eight time, repeating the generating by applying the SFC algorithm corresponding to the SFC mode selected at the seventh time to the sub-signals of the another plurality of input audio signals.

The fifth time may be a given time period after the first time, the sixth time may be the given period after the second time, the seventh time may be the given period after the third time, and the eighth time may be the given period after the fourth time. The given time period may be based on a sampling frequency of an (or the) image sensor.

There is provided an apparatus configured to perform any of the methods described herein.

The apparatus may comprise one or more processors. The processors may be configured to perform any of the methods described herein.

The apparatus may comprise a digital signal processor configured to perform any of the methods described herein.

The apparatus may comprise the array of loudspeakers.

The apparatus may be coupled, or may be configured to be coupled, to the loudspeaker array.

There is provided a vehicle, such as a car, comprising the apparatus.

There is provided a computer program comprising instructions which, when executed by a processing system, cause the processing system to perform any of the methods described herein.

There is provided a (non-transitory) computer-readable medium or a data carrier signal comprising the computer program.

There is provided a computer-readable medium storing instructions which, when executed by a processing system, cause the processing system to perform any of the methods described herein.

In some implementations, the various methods described above are implemented by a computer program. In some implementations, the computer program includes computer code arranged to instruct a computer to perform the functions of one or more of the various methods described above. In some implementations, the computer program and/or the code for performing such methods is provided to an apparatus, such as a computer, on one or more computer-readable media or, more generally, a computer program product. The computer-readable media is transitory or non-transitory. The one or more computer-readable media could be, for example, an electronic, magnetic, optical, electromagnetic, infrared, or semiconductor system, or a propagation medium for data transmission, for example for downloading the code over the Internet. Alternatively, the one or more computer-readable media could take the form of one or more physical computer-readable media such as semiconductor or solid-state memory, magnetic tape, a removable computer diskette, a random-access memory (RAM), a read-only memory (ROM), a rigid magnetic disc, or an optical disk, such as a CD-ROM, CD-R/W or DVD.

In an implementation, the modules, components and other features described herein are implemented as discrete components or integrated in the functionality of hardware components such as ASICS, FPGAs, DSPs or similar devices.

A ‘hardware component’ is a tangible (e.g., non-transitory) physical component (e.g., a set of one or more processors) capable of performing certain operations and configured or arranged in a certain physical manner. In some implementations, a hardware component includes dedicated circuitry or logic that is permanently configured to perform certain operations. In some implementations, a hardware component is or includes a special-purpose processor, such as a field programmable gate array (FPGA) or an ASIC. In some implementations, a hardware component also includes programmable logic or circuitry that is temporarily configured by software to perform certain operations.

Accordingly, the term ‘hardware component’ should be understood to encompass a tangible entity that is physically constructed, permanently configured (e.g., hardwired), or temporarily configured (e.g., programmed) to operate in a certain manner or to perform certain operations described herein.

In addition, in some implementations, the modules and components are implemented as firmware or functional circuitry within hardware devices. Further, in some implementations, the modules and components are implemented in any combination of hardware devices and software components, or only in software (e.g., code stored or otherwise embodied in a machine-readable medium or in a transmission medium).

### REFERENCES

[A] Tahereh Afghah, Elliot Patros, and Miller Puckette. “A pseudoinverse technique for the pressure-matching beamforming method”. In: Audio Engineering Society Convention 145. Audio Engineering Society. 2018.
[B] Jean-Paul Berrut and Lloyd N Trefethen. “Barycentric lagrange interpolation”. In: SIAM review 46.3 (2004), pp. 501-517.
[C] Tyler H Chang et al. “A polynomial time algorithm for multivariate interpolation in arbitrary dimension via the Delaunay triangulation”. In: Proceedings of the ACMSE 2018 Conference. 2018, pp. 1-8.
[D] Stephen J Elliott et al. “Robustness and regularization of personal audio systems”. In: IEEE Transactions on Audio, Speech, and Language Processing 20.7 (2012), pp. 2123-2133.
[E] Filippo Maria Fazi and Marcos Felipe Simon Galvez. “Sound reproduction system”. WO2017158338A1. Filed: 2017 Mar. 14. Sep. 21, 2017.
[F] Filippo Maria Fazi et al. “Loudspeaker control”. U.S. Pat. No. 11,792,596B2. Filed: 2021 Jun. 4. Oct. 17, 2023.
[G] Fabrice Katzberg et al. “Measurement of sound fields using moving microphones”. In: 2017 IEEE International Conference on Acoustics, Speech and Signal Processing (ICASSP). IEEE. 2017, pp. 3231-3235.
[H] Donald J. Meagher. “High-speed image generation of complex solid objects using octree encoding”. EP0152741B1. Filed: 1985 Jan. 9.
[I] Manfred R Schroeder. “The “Schroeder frequency” revisited”. In: The Journal of the Acoustical Society of America 99.5 (1996), pp. 3240-3241.
[J] Donald Shepard. “A two-dimensional interpolation function for irregularly-spaced data”. In: Proceedings of the 1968 23rd ACM national conference. 1968, pp. 517-524.
[K] Wikipedia contributors. Radial basis function interpolation-Wikipedia, The Free Encyclopedia. [Online; accessed 16 Dec. 2024]. 2024. URL: https://en.wikipedia.org/w/index.php?title=Radial_basis_function_interpolation& oldid=1260037060.

### Interpretation

Section titles are provided above to ease understanding of the disclosure, and are not to be construed as limiting the scope of the disclosure.

In the present disclosure, when a particular SFC mode is described as being the ‘selected’ SFC mode under particular circumstances (e.g., at a particular frequency, or when a CP is at particular distance from the array), it should be understood that that particular SFC mode may be selected based on, or responsive to, a determination that those circumstances apply.

It will be appreciated that, although various approaches above may be implicitly or explicitly described as ‘optimal’, engineering involves trade-offs and so an approach which is optimal from one perspective may not be optimal from another. Furthermore, approaches which are slightly sub-optimal may nevertheless be useful. As a result, both optimal and sub-optimal solutions should be considered as being within the scope of the present disclosure.

Those skilled in the art will recognize that a wide variety of modifications, alterations, and combinations can be made with respect to the above described examples without departing from the scope of the disclosed concepts, and that such modifications, alterations, and combinations are to be viewed as being within the scope of the present disclosure.

Those skilled in the art will also recognize that the scope of the invention is not limited by the examples described herein, but is instead defined by the appended claims.

1. A computer-implemented method of generating audio signals for an array of loudspeakers in a plurality of frequency bands, comprising:
obtaining the plurality of frequency bands;
receiving a plurality of input audio signals to be reproduced, by the array, in an acoustic environment, wherein each of the plurality of input audio signals comprises a sub-signal in each of the plurality of frequency bands, and wherein each of the sub-signals in at least one of the plurality of frequency bands is to be reproduced at a respective subset of a set of control points, CPs;
receiving position information indicative of a position of each of a mobile subset of the set of CPs;
selecting, from a set of predetermined Sound Field Control, SFC, modes and based on the position information, a respective SFC mode for each of the plurality of frequency bands; and
generating a respective output audio signal for each of the loudspeakers in the array by applying, for each of the plurality of frequency bands, an SFC algorithm corresponding to the SFC mode selected for the frequency band to the sub-signals of the frequency band.

2. The method of claim 1, wherein the plurality of frequency bands comprises at least one of a first, a second, a third, or a fourth frequency band.

3. The method of claim 2, wherein at least one of:
the SFC mode selected for the first frequency band is a control-point-position-independent mode;
the SFC mode selected for at least one of the second, third or fourth frequency bands is a respective control-point-position-dependent mode and uses a set of transfer functions, TFs, each TF being between an audio signal applied to a respective one of the loudspeakers and an audio signal received at a respective one of the set of CPs from the respective one of the loudspeakers;
the set of TFs used in the SFC mode selected for the second frequency band is a set of measured TFs;
the set of TFs used in the SFC mode selected for the third frequency band comprises at least one of a set of measured TFs or a set of modelled TFs; or
the set of TFs used in the SFC mode selected for the fourth frequency band is a set of modelled TFs.

4. The method of claim 3, wherein the set of TFs used in the SFC mode selected for the third frequency band comprises a set of hybrid measured and modelled TFs, wherein a first part of each of the hybrid measured and modelled TFs, at frequencies below a transition frequency within the third frequency band, is measured, and a second part of each of the hybrid measured and modelled TF, at frequencies above the transition frequency, is modelled.

5. The method of claim 4, wherein the transition frequency is specific to each of the loudspeakers and each of the CPs and is based on a respective distance between the loudspeaker and the CP,
optionally wherein a first transition frequency for a first loudspeaker and a first CP is based on a first distance between the first loudspeaker and the first CP, a second transition frequency for a second loudspeaker and a second CP is based on a second distance between the second loudspeaker and the second CP, the first transition frequency is higher than the second transition frequency, and the first distance is smaller than the second distance.

6. The method of claim 3, wherein the selecting of the SFC mode for the third frequency band comprises selecting, for each of the loudspeakers and each of the respective subsets of the set of CPs for the third frequency band and based on a respective distance between the loudspeaker and the CP, one of a first SFC sub-mode that uses a set of measured TFs and a second SFC sub-mode that uses a set of modelled TFs, optionally wherein the selecting of the one of the first or second SFC sub-modes comprises selecting the second SFC sub-mode responsive to determining that the distance is above a threshold distance.

7. The method of claim 3, wherein each of the TFs of the set of TFs or the set of measured TFs is measured at a respective CP of a sampling grid having a given density, and wherein at least one of:
the given density is not uniform across the sampling grid;
the sampling grid is more dense around an expected position of a head and/or an ear of each of one or more listeners;
the given density is frequency-dependent;
the sampling grid has a respective given density for each of the plurality of frequency bands, optionally wherein at least one of:
the given density for a particular frequency band is based on at least one of a lower limit or an upper limit of the particular frequency band; or
the given density for the second frequency band is lower than the given density for the third frequency band.

8. The method of claim 7, wherein the sampling grid has the respective given density for each of the plurality of frequency bands, and wherein at least one of:
the given density for the second frequency band has a peak of at most 25 cm between adjacent CPs of the sampling grid;
the given density for the third frequency band has a peak of at most one quarter of a wavelength of an upper limit of the third frequency band between adjacent CPs of the sampling grid.

9. The method of claim 2, wherein at least one of:
the first frequency band is lower than at least one of the second frequency band, the third frequency band or the fourth frequency band;
the second frequency band is lower than at least one of the third frequency band or the fourth frequency band;
the third frequency band is lower than the fourth frequency band;
the second frequency band is higher than the first frequency band;
the third frequency band is higher than at least one of the first frequency band or the second frequency band;
the fourth frequency band is higher than at least one of the first frequency band, the second frequency band or the third frequency band.

10. The method of claim 2, wherein at least one of:
a lower limit of the first frequency band is at most 20 Hz;
an upper limit of the first frequency band is between 60 and 100 Hz;
a lower limit of the second frequency band is between 60 and 100 Hz;
an upper limit of the second frequency band is between 200 and 300 Hz;
a lower limit of the third frequency band is between 200 and 300 Hz;
an upper limit of the third frequency band is between 1 and 3 kHz;
a lower limit of the fourth frequency band is between 1 and 3 kHz;
an upper limit of the fourth frequency band is at least 20 kHz.

11. The method of claim 2, wherein:
the SFC algorithm corresponding to the SFC mode for the second frequency band is one of an energy contrast SFC algorithm or a crosstalk cancellation SFC algorithm;
the SFC algorithm corresponding to the SFC modes for the third and/or fourth frequency bands is a crosstalk cancellation SFC algorithm.

12. The method of claim 2, wherein at least one of:
in the second frequency band, the respective subsets of the set of CPs are at or around a head of at least one listener; or
in at least one of the second, third or fourth frequency bands, the respective subsets of the set of CPs are at or around an ear of at least one listener.

13. The method of claim 12, wherein the position information is received from a head tracking system for tracking head movements of one or more listeners.

14. The method of claim 13, wherein the acoustic environment is a vehicle, such as a car, optionally wherein the frequency bands are determined based on a geometry of the vehicle.

15. The method of claim 14, further comprising:
receiving a plurality of source audio signals from a plurality of respective sources; and
wherein the plurality of input audio signals are determined based on the plurality of source audio signals, and wherein at least one of:
at least two of the plurality of input audio signals are determined based on a same source audio signal;
at least one of the plurality of input audio signals is determined based on two or more of the plurality of source audio signals.

16. The method of claim 15, wherein at least one of:
the set of CPs comprises a static subset;
the set of CPs, or the mobile subset of the set of CPs, comprises CPs at or around a head of at least one listener;
the set of CPs, or the mobile subset of the set of CPs, comprises CPs at or around an ear of at least one listener;
the respective subset of the set of CPs for a first one of the plurality of input audio signals in a first one of the plurality of frequency bands is different from the respective subset of the set of CPs for the first one of the plurality of input audio signals in a second one of the plurality of frequency bands; or
the respective subset of the set of CPs for a third one of the plurality of input audio signals in a third one of the plurality of frequency bands is different from the respective subset of the set of CPs for a fourth one of the plurality of input audio signals in the third one of the plurality of frequency bands.

17. The method of claim 16, wherein the output audio signal for a given loudspeaker in the array comprises a respective output sub-signal in at least one of the plurality of frequency bands, optionally a respective output sub-signal in at least two of the plurality of frequency bands, further optionally a respective output sub-signal in each of the plurality of frequency bands.

18. The method of claim 1, wherein the method further comprises:
subsequent to the receiving of the plurality of input audio signals, separating each input audio signal of the plurality of input audio signals into the sub-signals in each of the plurality of frequency bands,
wherein applying the SFC algorithm comprises applying, to each one of the sub-signals and separately from the other sub-signals, the SFC algorithm to yield, for each of the loudspeakers, a respective output sub-signal in at least one of the plurality of frequency bands; and
combining, for each of the loudspeakers, the respective output sub-signals from the at least one of the plurality of frequency bands to yield the respective output audio signal,
or wherein the applying comprises:
generating, based on the SFC algorithms corresponding to the SFC modes selected for each of the plurality of frequency bands, a common set of digital signal processing, DSP, coefficients; and
applying the common set of DSP coefficients to the plurality of input audio signals to yield the respective output audio signal for each of the loudspeakers.

19. Apparatus comprising one or more processors and configured to perform a method of generating audio signals for an array of loudspeakers in a plurality of frequency bands, the method comprising:
obtaining the plurality of frequency bands;
receiving a plurality of input audio signals to be reproduced, by the array, in an acoustic environment, wherein each of the plurality of input audio signals comprises a sub-signal in each of the plurality of frequency bands, and wherein each of the sub-signals in at least one of the plurality of frequency bands is to be reproduced at a respective subset of a set of control points, CPs;
receiving position information indicative of a position of each of a mobile subset of the set of CPs;
selecting, from a set of predetermined Sound Field Control, SFC, modes and based on the position information, a respective SFC mode for each of the plurality of frequency bands; and
generating a respective output audio signal for each of the loudspeakers in the array by applying, for each of the plurality of frequency bands, an SFC algorithm corresponding to the SFC mode selected for the frequency band to the sub-signals of the frequency band,
optionally wherein the apparatus is provided in a vehicle, such as a car, comprising the apparatus.

20. A computer-readable medium storing instructions which, when executed by a processing system, cause the processing system to perform a method of generating audio signals for an array of loudspeakers in a plurality of frequency bands, the method comprising:
obtaining the plurality of frequency bands;
receiving a plurality of input audio signals to be reproduced, by the array, in an acoustic environment, wherein each of the plurality of input audio signals comprises a sub-signal in each of the plurality of frequency bands, and wherein each of the sub-signals in at least one of the plurality of frequency bands is to be reproduced at a respective subset of a set of control points, CPs;
receiving position information indicative of a position of each of a mobile subset of the set of CPs;
selecting, from a set of predetermined Sound Field Control, SFC, modes and based on the position information, a respective SFC mode for each of the plurality of frequency bands; and
generating a respective output audio signal for each of the loudspeakers in the array by applying, for each of the plurality of frequency bands, an SFC algorithm corresponding to the SFC mode selected for the frequency band to the sub-signals of the frequency band.
